(19) United States
(12) Patent Application Publication
(10) Pub. No.: US 2026/0365324 A1
(43) Pub. Date: Nov. 19, 2026

(54) Compact Flight Line Ground Support System

(71) Applicant: Energy Quest Technologies Inc., Apache Junction, AZ (US)

(72) Inventor: Dwayne M. Benson, Apache Junction, AZ (US)

(73) Assignee: Energy Quest Technologies Inc., Apache Junction, AZ (US)

(21) Appl. No.: 19/659,930

(22) Filed: Apr. 27, 2026

Related U.S. Application Data
(60) Provisional application No. 63/796,179, filed on Apr. 28, 2025.

(51) Int. Cl. B64F 1/35; B64F 1/36

(52) U.S. Cl. CPC B64F 1/352; B64F 1/364

(57) ABSTRACT

A ground support system includes a trailer frame. An engine is disposed on the trailer frame. The engine is oriented transverse to a longitudinal axis of the trailer frame. A gearbox has an input of the gearbox coupled to an output of the engine. The gearbox steps up a rotational speed of the engine to at least 6,000 rpm at an output of the gearbox. A generator is coupled to the output of the gearbox. An air duct is disposed on the trailer frame including an inlet and an outlet. A turbo-blower is disposed in the air duct. The turbo-blower is configured to be powered by the generator. A first evaporator coil disposed in the air duct upstream of the turbo-blower. A second evaporator coil disposed in the air duct downstream of the turbo-blower.

### CLAIM OF DOMESTIC PRIORITY

The present invention claims the benefit of U.S. Provisional Application No. 63/796,179, filed Apr. 28, 2025, which application is incorporated herein by reference.

### FIELD OF THE INVENTION

The present invention relates in general to ground support equipment (GSE) for aircraft, and, more particularly, to a single-pallet or smaller multi-capable ground support system in a compact package.

### BACKGROUND OF THE INVENTION

Aircraft stationed at military installations and commercial airports require ground support equipment to provide environmental control, electrical power, and other services while the aircraft is on the ground with its engines off. Pre-conditioned air (PCA) units deliver temperature-controlled, dehumidified air to the aircraft cabin and avionics bays. Generator sets (gensets) supply electrical power at the voltages and frequencies required by aircraft systems. In some applications, equipment must additionally provide bleed air at sufficient pressure and flow to operate an aircraft's onboard environmental control system (ECS) or to perform engine air starts.

Existing ground support equipment typically requires multiple separate trailers or carts to provide these functions simultaneously. A PCA unit, a separate generator, a separate dehumidifier, and a separate bleed air cart may each occupy a full pallet or larger footprint. Reducing the number and size of ground support equipment items is a critical operational requirement. Therefore, a need exists for a ground support system with compact size that provides all the necessary ground support equipment while achieving dramatic reductions in weight and volume compared to prior systems.

One prior art system that occupies two pallets is disclosed in U.S. Pat. No. 12,202,626, granted Jan. 21, 2026, and U.S. Provisional Application No. 63/178,975, filed Apr. 23, 2021, both of which are incorporated herein by reference.

### BRIEF DESCRIPTION OF THE DRAWINGS

FIGS. 1a-1f illustrate a single-pallet multi-capable ground support system;

FIGS. 2a-2e illustrate an electrical generation section of the ground support system;

FIGS. 3a-3e illustrate an air handling and duct system of the ground support system;

FIGS. 4a-4e illustrate refrigeration system embodiments of the ground support system;

FIGS. 5a-5d illustrate an optional electric bleed air module for the ground support system;

FIGS. 6a and 6b illustrate an optional polyalphaolefin (PAO) liquid cooling system for the ground support system;

FIGS. 7a and 7b illustrate an optional self-propelled drive system for the ground support system;

FIGS. 8a and 8b illustrate an optional area lighting system for the ground support system; and

FIGS. 9a-9i illustrate a man-portable power unit.

### Detailed Description of the Drawings

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

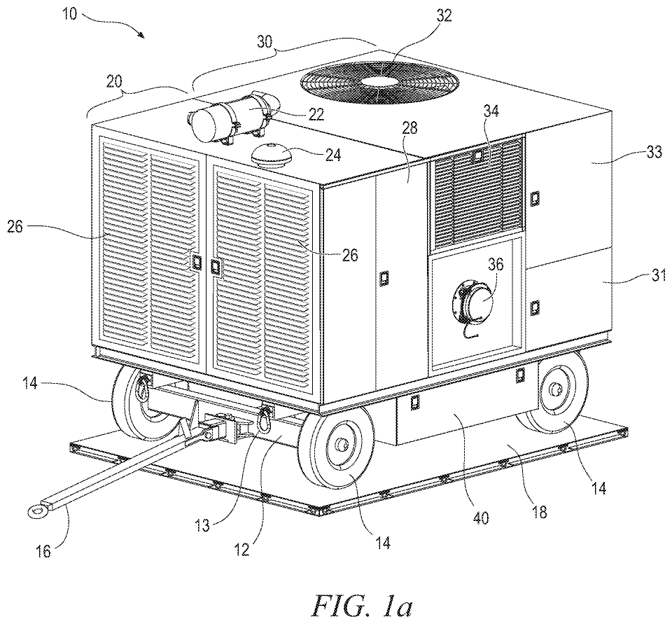

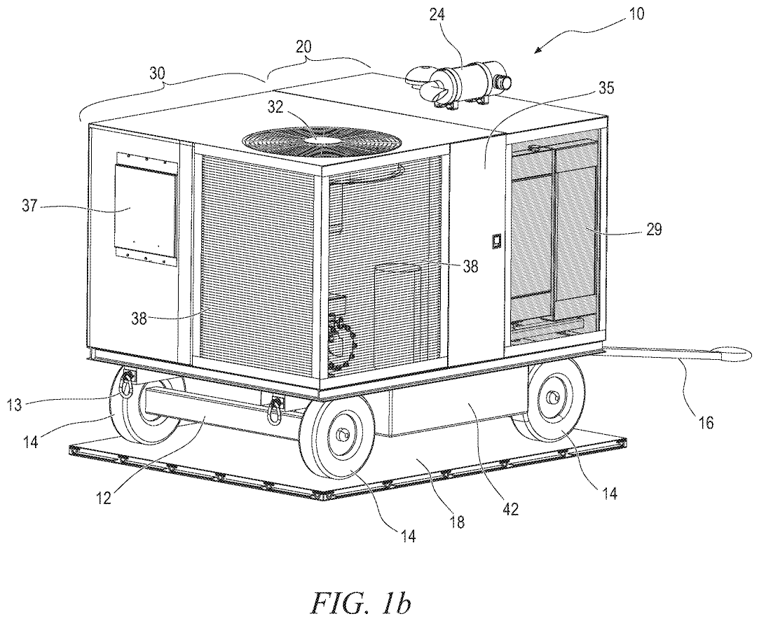

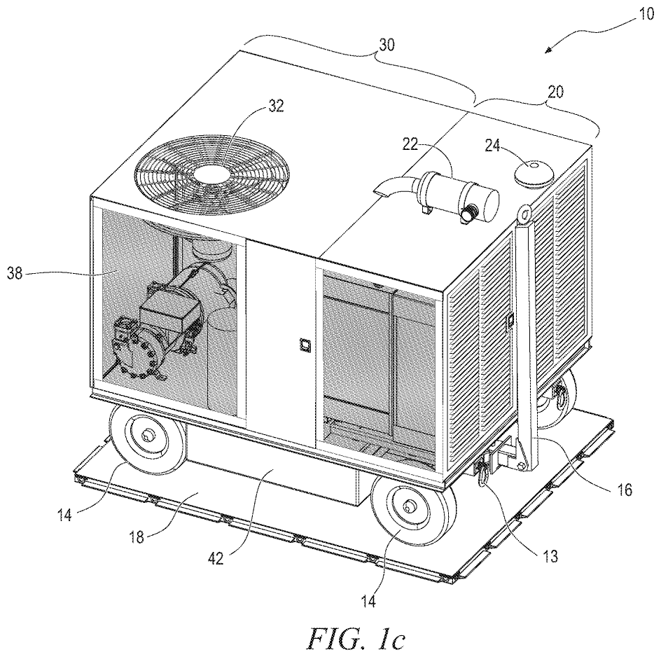

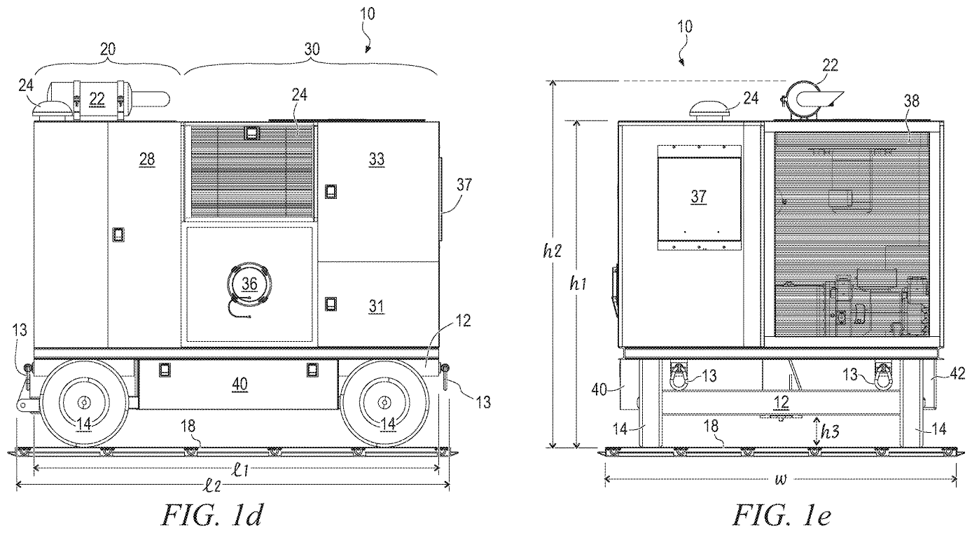

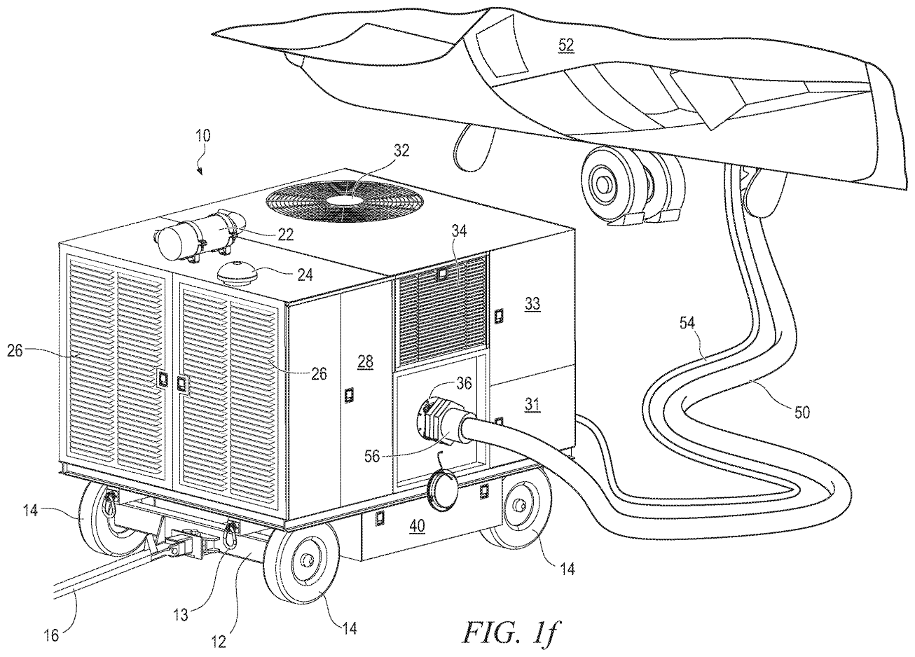

FIG. 1a-1f illustrate a ground support system 10. FIG. 1a is a perspective view of the complete trailer from the front-left, FIG. 1b is a rear-right perspective, and FIG. 1c is a front-left perspective. FIG. 1d is a side view from the left and FIG. 1e is a rear view. Ground support system 10 is a single-pallet, multi-capable unit configured to simultaneously provide pre-conditioned air, electrical power, dehumidification, and, in optional configurations described further below, bleed air, polyalphaolefin (PAO) liquid cooling, self-propelled mobility, and other features. Ground support system 10 is sized and configured to fit within the footprint of a single standard 463 L military airlift pallet having a usable area of 104 inches by 84 inches, with a trailer envelope of 100 inches long by 78 inches wide by 88 inches tall. This represents half the footprint of prior two-pallet ground support systems offering comparable or lesser capability. The dimensions of the final product may be different while still fitting within the 463 L pallet usable area.

Ground support system 10 includes a trailer frame 12 supported on a plurality of wheels 14. Wheels 14 are tubeless or pneumatic vehicle or trailer wheels disposed on a pair of trailer axles as part of frame 12. Frame 12 is sized with a length and width configured to fit on a 463 L pallet 18 and includes tiedown rings 13 for attaching ground support system 10 to the pallet. Ground support system 10 has four tiedown rings 13, one on each corner. Additional tiedown rings 13 can be added as necessary.

A towbar 16 extends from trailer frame 12 to allow ground support system 10 to be towed by a vehicle between aircraft. Ground support system 10 rolls on wheels 14 when pulled by a motorized vehicle via towbar 16. In one embodiment, towbar 16 is hinged and can be folded to a vertical stowed position when not in use, as shown in FIG. 1c. Towbar 16 is also removable when not needed, e.g., in self-propelled embodiments. A pallet 18 underlies trailer frame 12. Pallet 18 is a standard 463 L military airlift pallet, enabling ground support system 10 to be loaded aboard C-130, C-17, and other military cargo aircraft without any modification to the pallet interface. In some embodiments, pallet 18 remains with ground support system 10 during ground operations to serve as a base for the ground support system. Pallet 18 is used for transporting ground support system 10 while wheels 14 are used to roll the ground support system off the pallet to and between aircraft.

As shown in the perspective views of FIG. 1a-1c and the side view of FIG. 1d, ground support system 10 includes an electrical generation section 20 occupying approximately one-third of the trailer length at the front of the trailer and an air conditioning section 30 occupying approximately two-thirds of the trailer length toward the back of the trailer.

The external components of electrical generation section 20 include a muffler 22 and air intake 24 disposed on the roof of the electrical generation section for an internal combustion engine within the electrical generation section. Muffler 22 is connected to exhaust of the internal combustion engine to reduce noise. Intake 24 connects to an air filter canister inside the electrical generation section and then to the air intake of the engine.

Front doors 26 are louvered ventilation panels. Each front door 26 opens from the center, with a hinge on the outer edges, to allow access to the engine and generator while being vented or louvered to allow air flow through the front doors when closed. Door 28 opens to reveal a storage compartment for power cables. A grate 29 protects the internal radiators, including the engine coolant radiator and oil cooler, while allowing air flow through the radiators for cooling.

The external components of air conditioning section 30 include a condenser fan 32 disposed on the roof of ground support system 10, above the air conditioning section, to exhaust heat rejected by the refrigeration system upward and away from the trailer. An air inlet 34 for the air conditioning system has a grated or vented door with an air filter immediately inside the door. An air outlet 36 is disposed on a side face of air conditioning section 30 and is configured to accept a standard flexible air hose for connection to an aircraft. In one embodiment, air inlet 34 uses a 24-inch square air filter and air outlet 36 is an eight-inch diameter hose connection. Air is pulled in through inlet 34, processed by air conditioning section 30, and then blown out through outlet 36. Condenser coils 38 occupy a back-right corner of ground support system 10, being split into two separate sections that separately swing open for service. Condenser coils 38 operate as part of the AC system, being cooled by airflow from condenser fan 32.

Beneath trailer frame 12, an access door 40 is disposed on the left underside of ground support system 10, providing a compartment or drawer configured to receive additional subsystems or accessories. A fuel tank 42 is disposed on the right underside of ground support system 10, beneath electrical generation section 20, and holds 100 gallons of diesel fuel sufficient for 10 hours of continuous operation at full load.

Door 31 opens to reveal a storage compartment for air hoses. Door 33 opens to reveal the motor drives and other electronic systems for ground support system 10. Door 35 opens to reveal power inverters used to generate the electrical signals necessary for aircraft ground support. Door 37 opens to reveal the user interface for ground support system 10, such as system controls, displays, and fault indicators.

As shown in the side elevation views of FIGS. 1d and 1e, ground support system 10 presents a substantially rectangular profile sized to fit within the 463 L pallet envelope. FIG. 1d shows the side of ground support system 10 on which air inlet 34 and outlet 36 are visible. FIG. 1e shows the rear of ground support system 10, on which condenser coil 38 and door 37 are visible.

FIG. 1d illustrates a length of ground support system 10. The label L1 shows that frame 12 of ground support system 10 has a base length L1 of 96 inches. The total length L2 of ground support system 10, including folded-up towbar 16 and tiedown rings 13, is 100 inches. FIG. 1e shows ground support system 10 with a total width W of 78 inches, a base height H1 of 78 inches, and a total height H2 of 88 inches including muffler 22, well within the height envelope for common military cargo aircraft. The dimension H3 shows a ground clearance of 9 inches. The dimensions may vary in other embodiments, but ground support system 10 still fits within the pallet 18 usable envelope.

FIG. 1f illustrates ground support system 10 deployed in operation, with a flexible pre-conditioned air hose 50 connected between air outlet 36 and an environmental control inlet of an aircraft 52. Hose 50 has a connector 56 configured to attach to outlet 36. An electrical cable 54 connects to a connector on electrical generation section 20 and carries electrical current from the electrical generation section to aircraft 52 to power the aircraft's electrical systems. Aircraft 52 is depicted as a fixed-wing military aircraft, though ground support system 10 is compatible with a wide range of military and commercial aircraft requiring ground support services. Ground support system 10 delivers temperature-controlled air through hose 50 to the aircraft's environmental control system, maintaining the aircraft cabin and avionics at desired temperature and humidity conditions while the aircraft is on the ground with its engines off. In one embodiment, ground support system 10 delivers at least 100 pounds per minute of air at 45-degrees Fahrenheit and at least 6 psig through air outlet 36.

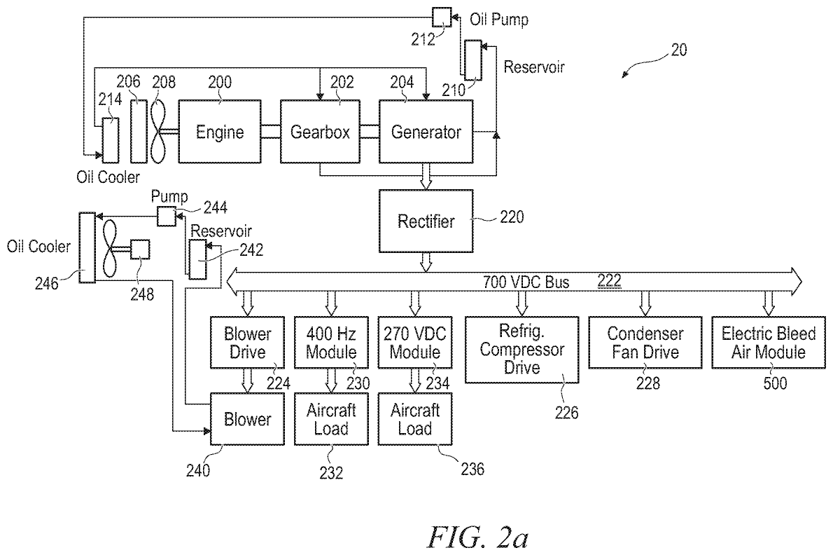

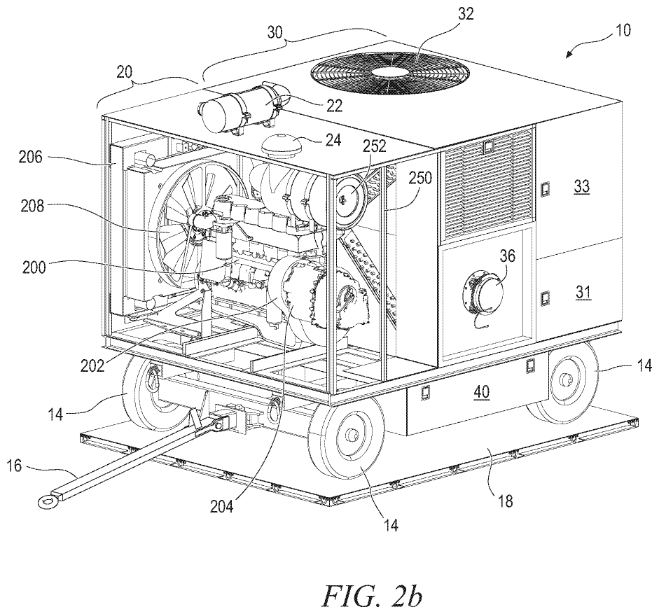

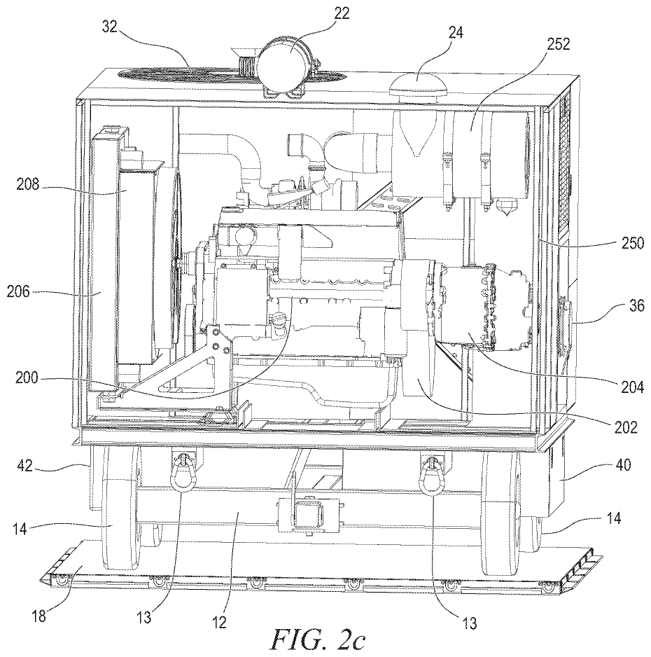

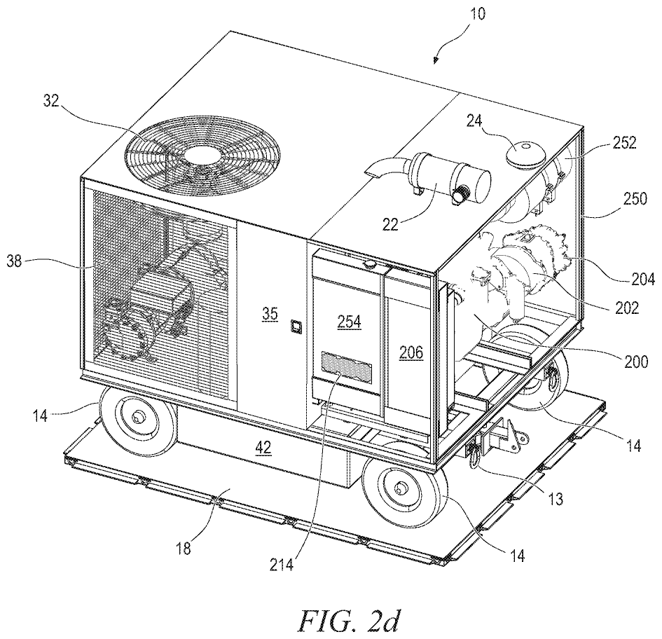

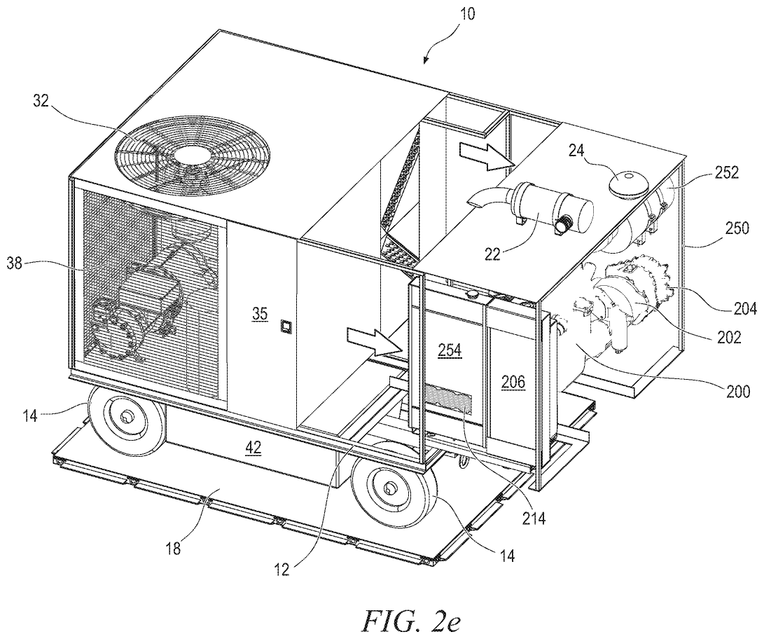

FIGS. 2a-2e illustrate details of electrical generation section 20. FIG. 2a is a block diagram showing the major components of electrical generation section 20. The primary components of electrical generation section 20 include engine 200, gearbox 202, and generator 204, which comprise a genset for the electrical generation section.

Engine 200 is a 6-cylinder military diesel engine that produces 327 horsepower in one embodiment to generate 200 kW electric power output. In other embodiments, a different sized engine is used to produce an electric power output of between 30 and 300 kW. Engine 200 is rated at 327 horsepower, providing margin above the power required to support the full electrical output of generator 204. The engine runs at 2,000 rotations per minute (rpm) in one embodiment. Any other suitable combustion engine is used in other embodiments to generate output power, and the engine operating speed is selected based on the power output requirements and engine characteristics.

A gearbox 202 is connected to the output shaft or power-takeoff (PTO) of engine 200. Gearbox 202 is a “step-up” gearbox that steps up the output shaft speed of engine 200 to a speed suitable for operating generator 204, which requires significantly higher rotational speeds than conventional generators, typically at least 6,000 rpm. Gearbox 202 has an output of 12,000 rpm in one embodiment. In another embodiment, gearbox 202 steps up the output shaft of engine 200 to 16,000 rpm. Gearbox 202 has a mechanical power output to generator 204 and steps up the output shaft from engine 200 for operating generator 204 at higher speeds.

Generator 204 is an aircraft generator rated for 225 kilovolt-amps (kVA) output. Generator 204 operating at 12,000 rpm from gearbox 202 allows a substantial size reduction for the generator. Ground support generators typically weigh 1,340 pounds in the prior art to output a comparable power while generator 204 weighs only 122 pounds. Increasing rpms allows a reduction from previous generators of about 1,200 pounds and 90% of the volume. At about 1.0 foot long, generator 204 is physically much smaller than generators used for ground support equipment in the prior art. Increasing the rpm allows a significant reduction in size and weight for generator 204. The result is a genset that has 50% more power and is still about 60% of the size and half the weight of previous systems, thus fitting within one-third of a single 463 L pallet footprint compared to one-half of a two-pallet footprint for prior systems.

Engine 200 includes an engine coolant radiator 206 and a radiator cooling fan 208 driven directly from the front of engine 200. Radiator cooling fan 208 draws ambient air through engine coolant radiator 206 to maintain engine coolant temperature within operating limits. Engine coolant radiator 206 and radiator cooling fan 208 are disposed within electrical generation section 20, with airflow directed through grate 29.

Generator 204 and gearbox 202 are cooled and lubricated by a dedicated oil circuit comprising an oil reservoir 210, an oil pump 212, and an oil cooler 214. Oil pump 212 circulates oil under pressure from reservoir 210 through generator 204 and gearbox 202, providing both lubrication of rotating components and removal of heat generated during operation. The heated oil is then passed through oil cooler 214, which rejects heat to ambient air before returning to reservoir 210. In one embodiment, oil cooler 214 is positioned within the airflow path of radiator cooling fan 208, such that the same fan that cools engine coolant radiator 206 also provides airflow through oil cooler 214, eliminating the need for a separate dedicated fan for the generator and gearbox oil circuit. In another embodiment, oil cooler 214 is served by a dedicated cooling fan to maintain adequate airflow through the cooler at ambient temperatures up to at least 125 degrees Fahrenheit. The oil circuit serves the dual purpose of lubrication and thermal management, allowing generator 204 to operate continuously at full rated output without overheating.

The alternating current (AC) electrical output of generator 204 is fed to rectifier 220, which converts the AC output to direct current (DC). Rectifier 220 produces a 700-volt DC bus 222, which serves as the central power distribution backbone of ground support system 10. All subsystems within ground support system 10 are powered from 700 VDC bus 222, rather than having some components mechanically driven by engine 200. In other embodiments 700 VDC bus 222 is a high-voltage DC bus operating at a voltage of at least 500 VDC.

This all-electric architecture represents a fundamental departure from prior ground support systems, in which subsystems such as the air conditioning blower, refrigerant compressor, and condenser fan were driven mechanically from the engine through belts, shafts, and gearboxes. By powering all subsystems electrically from a common high-voltage DC bus, ground support system 10 achieves significant freedom in packaging subsystems within the trailer envelope, since electrically driven components need not be physically located near the engine or connected to it by mechanical drive trains. This all-electric approach is a key enabler of the single-pallet form factor of ground support system 10.

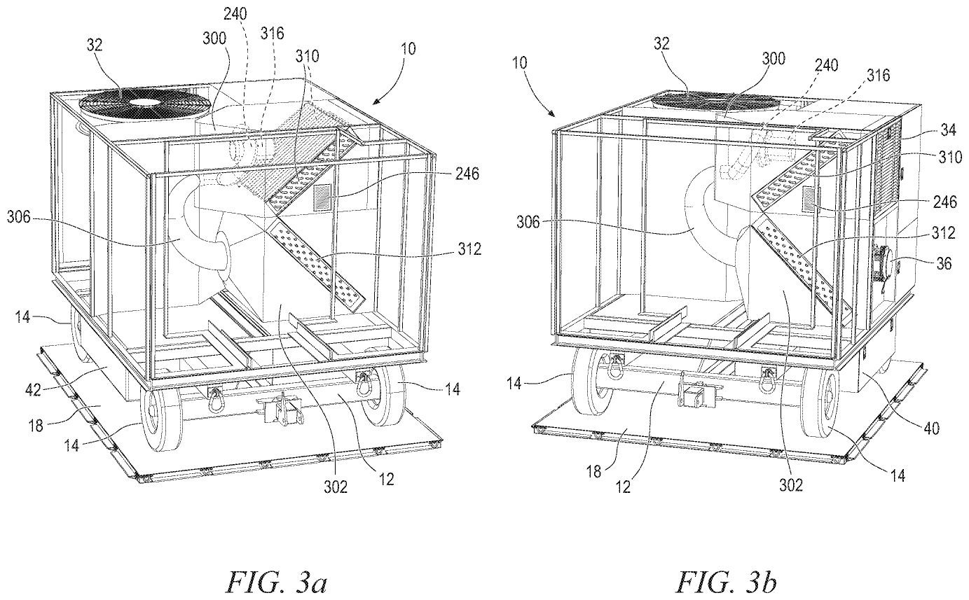

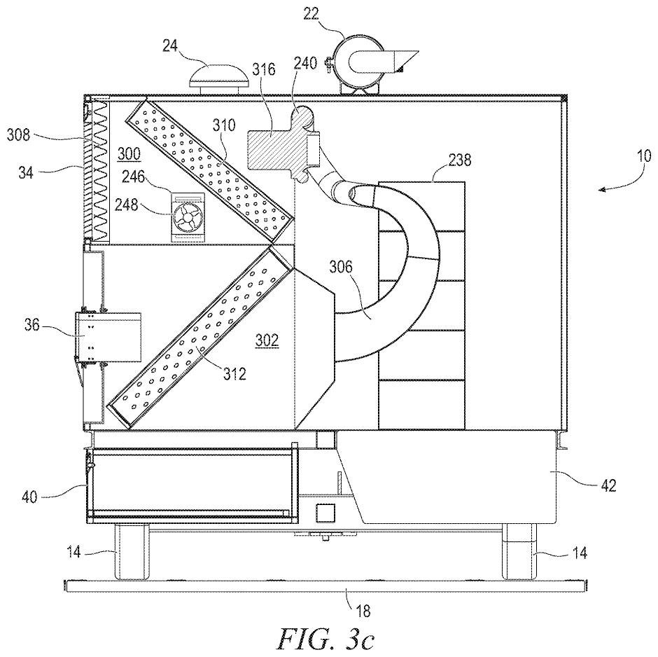

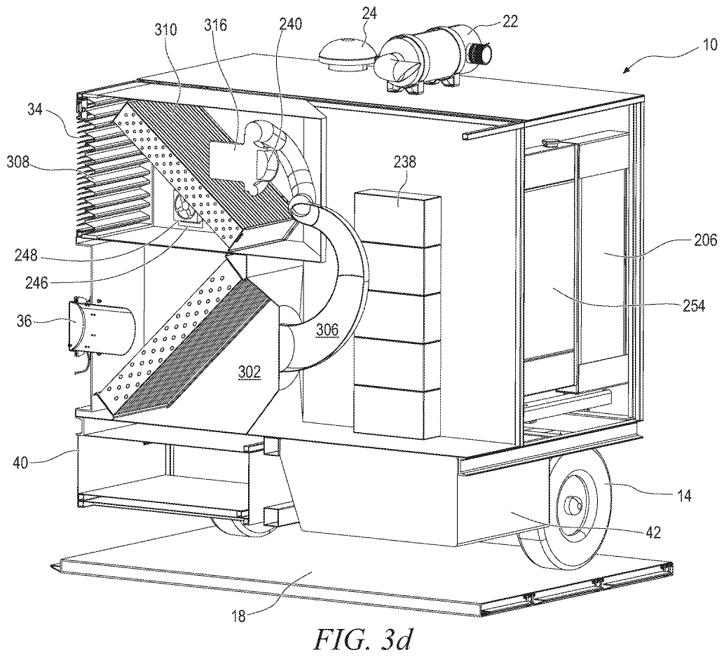

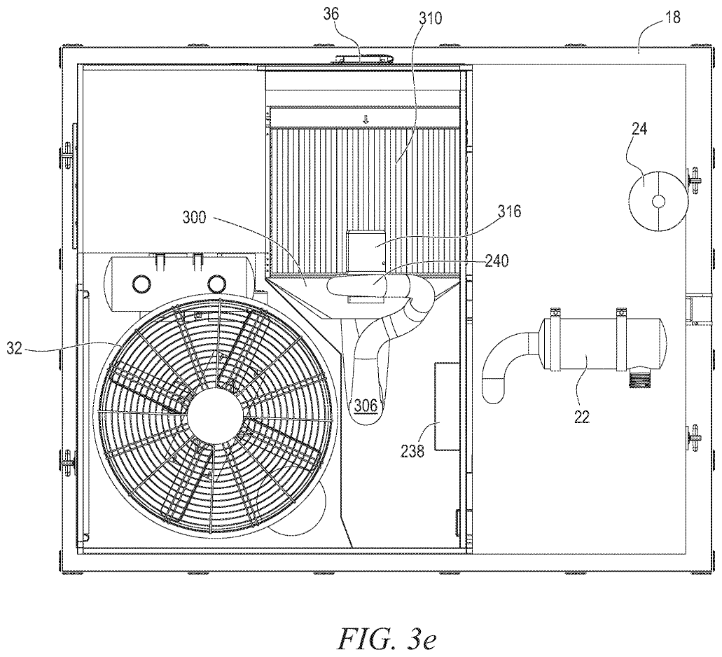

FIG. 2a shows several exemplary loads attached to 700 VDC bus 222, while other embodiments will use a subset of the illustrated loads or additional loads. A blower drive 224 receives power from 700 VDC bus 222 and drives the turbo-blower of air conditioning section 30, described further below. A refrigerant compressor drive 226 receives power from 700 VDC bus 222 and drives the refrigerant compressor of the refrigeration system described further below. A condenser fan drive 228 receives power from 700 VDC bus 222 and drives condenser fan 32. A 400 Hz power module 230 receives power from 700 VDC bus 222 and produces 400 Hz alternating current for delivery to aircraft load 232 of aircraft 52 if the aircraft has systems requiring 400 Hz power. A 270 VDC power module 234 receives power from 700 VDC bus 222 and produces 270-volt direct current for delivery to aircraft load 236 of aircraft 52 if the aircraft has systems requiring 270 VDC. In one embodiment, a 28 VDC output is also available from an additional converter connected to 700 VDC bus 222. An optional electric bleed air module 500 may also be powered from 700 VDC bus 222 when installed, as described further below. A stack of power inverters 238, including 400 Hz module 230 and 270 VDC module 234, is stored behind door 35 and visible in the cross-section of FIGS. 3c and 3d. Multiple inverter stacks 238 are used in other embodiments, e.g., one stack as pictured for 400 Hz module 230 and a second similar stack next to the pictured stack for 270 VDC module 234. A normal air compressor for shop air can be added in the available trailer space and powered by 700 VDC bus 222.

Ground support system 10 is configured to provide aircraft electrical power simultaneously at 400 Hz AC via 400 Hz power module 230 and at 270 VDC via 270 VDC power module 234, up to a combined total system load, equivalent to the generation capacity, depending on the particular embodiment. In one embodiment, up to 90 kVA, equivalent to approximately 72 kilowatts, is available for aircraft power while the air conditioning and refrigeration subsystems are operating simultaneously. All functions of ground support system 10 are available simultaneously until the total system load reaches its limit, at which point load management priorities apply.

Blower drive 224 powers turbo-blower 240, which is disposed within the ductwork of air conditioning section 30 and is described in further detail below with respect to FIGS. 3a-3e. Turbo-blower 240 is a high-speed centrifugal blower driven by an on-shaft electric motor operating at 30,000 rpm. Turbo-blower 240 operates at between 25,000 and 35,000 rpm in other embodiments. In one embodiment, turbo-blower 240 is rated at 60 horsepower and is capable of producing 1,500 cubic feet per minute of airflow at up to 8 psig, delivering at least 100 pounds per minute of conditioned air at 6 psig or greater to air outlet 36.

Turbo-blower 240 is cooled and lubricated by a dedicated oil circuit comprising an oil reservoir 242, an oil pump 244, and an oil cooler 246. Oil pump 244 circulates oil under pressure from reservoir 242 through the motor and bearing assemblies of turbo-blower 240, providing both lubrication of high-speed rotating components and removal of heat generated during operation. The heated oil is returned through oil cooler 246, which rejects heat to ambient air before returning to reservoir 242. In one embodiment, oil cooler 246 includes a dedicated cooling fan 248. In another embodiment, oil cooler 246 is positioned within an existing airflow path within ground support system 10, such as the airflow path of radiator cooling fan 208, eliminating the need for a dedicated fan.

FIGS. 2b-2d illustrate electrical generation section 20 with exterior panels removed to reveal the internal components of the genset. FIG. 2b is a front-left perspective view of electrical generation section 20 with exterior panels removed. FIG. 2c is a straight-on front view of electrical generation section 20 with exterior panels removed, showing the full transverse extent of the genset assembly from radiator cooling fan 208 on one end of engine 200 to gearbox 202 and generator 204 on the other end. FIG. 2d is a front-right perspective view of electrical generation section 20 with exterior panels removed.

Engine 200, gearbox 202, and generator 204 are mounted on genset subframe 250 with their long axes oriented transversely with respect to the long or longitudinal axis of trailer frame 12, meaning the crankshaft axis of engine 200 and the shaft axis of generator 204 run perpendicular to the direction of travel of ground support system 10. This transverse orientation is a critical feature of ground support system 10 and a key enabler of the single-pallet form factor. In prior ground support systems, the engine and generator were oriented longitudinally, with their long axes parallel to the trailer length, consuming one-half of a two-pallet footprint for the genset alone. By orienting the genset transversely and using the compact high-speed generator 204, the complete genset assembly fits within one-third of the single 463 L pallet footprint of ground support system 10, freeing the remaining two-thirds for air conditioning section 30 and the other subsystems. A single-pallet design at this power level would not be achievable without this transverse orientation.

Engine air intake 24 is disposed on the roof of electrical generation section 20 and admits ambient air into engine air filter canister 252 located within electrical generation section 20 below the roofline. Engine air filter canister 252 contains a replaceable air filter element that removes particulates from intake air before it enters engine 200. Locating engine air filter canister 252 internally within electrical generation section 20 protects the filter element from weather and physical damage while keeping the exterior profile of ground support system 10 within the 463 L pallet height envelope.

Radiator cooling fan 208 is disposed on one end of engine 200 and is driven directly from the engine crankshaft. Engine coolant radiator 206 is mounted between radiator cooling fan 208 and the exterior panel of electrical generation section 20, such that radiator cooling fan 208 draws ambient air in through grate 29 and through engine coolant radiator 206. Alternatively, cooling fan 208 blows air through coolant radiator 206 and out grate 29. Gearbox 202 and generator 204 are disposed on the opposite end of engine 200 from radiator cooling fan 208, with generator 204 oriented such that its electrical output connects to rectifier 220 within electrical generation section 20. Gearbox 202 is positioned physically between engine 200 and generator 204, and collectively the three components fit longitudinally within trailer frame 12 with a short enough length to fit within the shorter dimension of a single 463 L pallet.

As shown in FIG. 2d, an intercooler 254 is disposed within electrical generation section 20 in the airflow path of radiator cooling fan 208. Engine 200 is equipped with a turbocharger that compresses intake air prior to delivery to the engine cylinders. Compression of intake air by the turbocharger raises the air temperature significantly, reducing its density and oxygen content. Intercooler 254 cools the compressed intake air after it exits the turbocharger and before it enters engine 200, restoring air density and increasing the oxygen content of each cylinder charge, improving combustion efficiency, and allowing engine 200 to produce greater power output for a given displacement. Generator and gearbox oil cooler 214 are positioned within the same airflow path as intercooler 254, engine coolant radiator 206, or both, so that radiator cooling fan 208 simultaneously provides airflow through all three radiators.

FIG. 2e illustrates genset subframe 250 in a maintenance position, slideably extended outward from trailer frame 12. Genset subframe 250, carrying engine 200, gearbox 202, generator 204, and associated components, slides laterally outward on rails integrated into trailer frame 12 to extend beyond the footprint of the trailer frame, providing unobstructed access to all sides of the genset assembly for maintenance, inspection, and component replacement. In the maintenance position shown in FIG. 2e, the interior cavity of electrical generation section 20 is exposed, and gearbox 202 and generator 204 are fully accessible without requiring removal of any structural components of ground support system 10. Genset subframe 250 slides back into trailer frame 12 and is secured in the operating position for normal operation and transport. This slide-out maintenance feature significantly reduces maintenance time and improves accessibility in field environments where overhead lifting equipment may not be available.

The genset of electrical generation section 20 provides significant operational and maintenance cost advantages over prior ground support equipment. Compared to the widely used turbine-based ground support systems of comparable capability, ground support system 10 represents reductions of approximately 75% in fuel consumption, 80% in overhaul frequency, and over 95% in overhaul cost. These improvements result from the use of a modern, fuel-efficient diesel engine 200 operating under its rated capacity, combined with high-speed aircraft generator 204, which have demonstrated reliability in commercial aviation service.

FIGS. 3a-3e illustrate the air handling and duct system of air conditioning section 30 in detail. FIG. 3a is a front-right perspective view with electrical generation section 20 removed to reveal the external duct structure and conical expansion duct connecting the upper and lower duct portions. FIG. 3b is a front-left perspective view. FIGS. 3a and 3b both show structures internal to the ducts with dotted lines, including the pre-cooler and post-cooler evaporator coils and the turbo-blower within the upper duct. FIGS. 3c and 3d show the same cross-section of air conditioning section 30 taken from the rear. FIG. 3c is a straight-on elevation and FIG. 3d is an angled perspective from the rear-right. FIG. 3e is a top-down view with the roof panel removed, showing the spatial arrangement and footprint of the duct system components within the single-pallet envelope.

Air conditioning section 30 comprises an upper duct 300 and a lower duct 302, with turbo-blower 240 disposed within upper duct 300 and connected to lower duct 302 through a conical expansion duct 306. Turbo-blower 240 is a centrifugal compressor driven by a direct-drive electric motor 316 mounted on the same shaft as the compressor wheel, operating at 30,000 rpm. In other embodiments, turbo-blower 240 operates at between 20,000 rpm and 70,000 rpm. Motor 316 is powered by blower drive 224 from 700 VDC bus 222. By mounting motor 316 directly on the compressor shaft, turbo-blower 240 eliminates the gearbox, belts, and separate motor housing required by conventional blower drive systems, allowing the entire assembly to fit within upper duct 300 at approximately 10 inches in length and 8 inches in diameter. In one embodiment, turbo-blower 240 is rated at 60 horsepower and weighs 30 pounds, representing a weight reduction of 900 pounds compared to a conventional 60-horsepower industrial motor and blower drive system of equivalent output. Turbo-blower 240 is accessible for maintenance by removing a roof panel of air conditioning section 30. Due to the light weight of turbo-blower 240, the unit can be lifted out by hand for inspection, servicing, or replacement without requiring lifting equipment, significantly reducing maintenance burden in field environments.

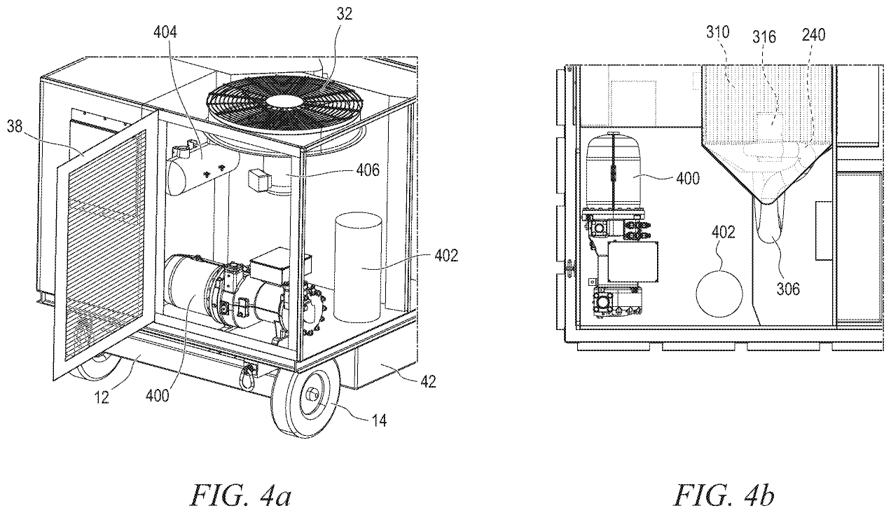

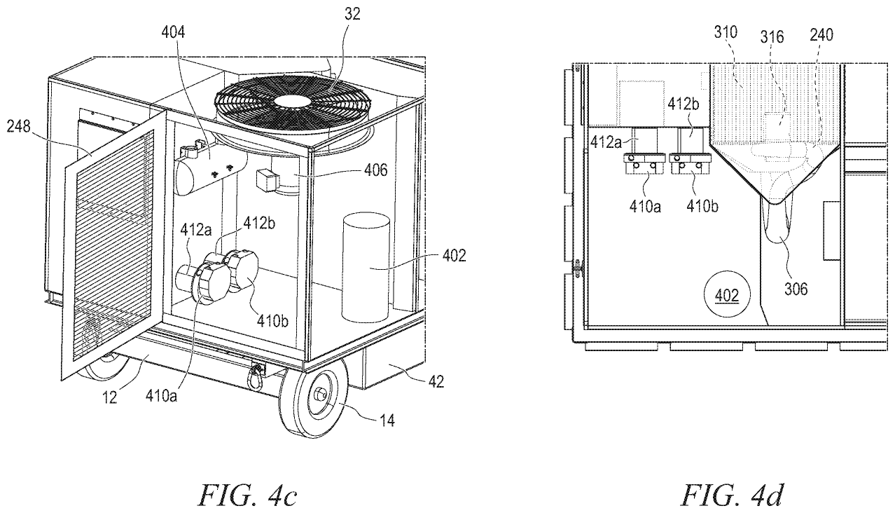

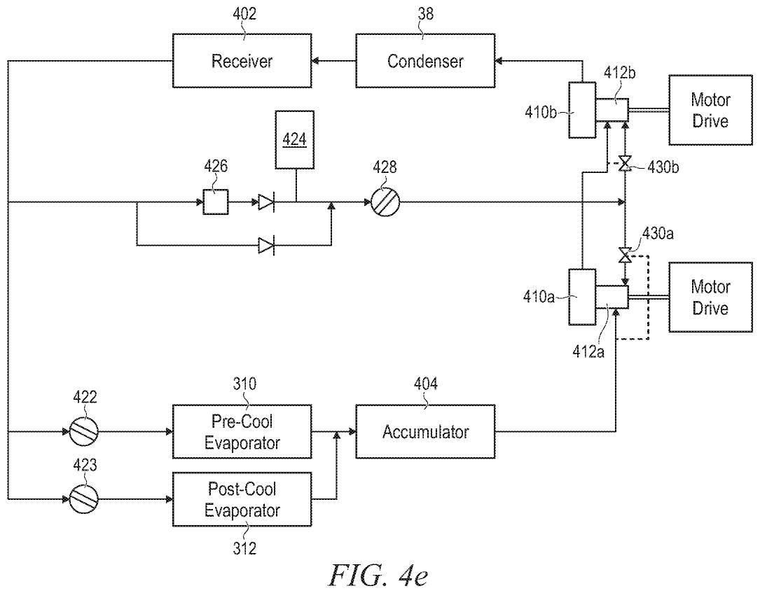

Ambient air enters air conditioning section 30 through air inlet 34 and passes through a 24-inch by 24-inch air filter 308 mounted just inside air inlet 34, which removes particulates from the incoming air stream. Pre-cooler evaporator coil 310 is disposed diagonally within upper duct 300 downstream of air filter 308, and post-cooler evaporator coil 312 is disposed diagonally within lower duct 302 upstream of air outlet 36. Both pre-cooler evaporator coil 310 and post-cooler evaporator coil 312 are oriented at an angle to the airflow direction to increase coil face area within the available duct cross-section. Pre-cooler evaporator coil 310 and post-cooler evaporator coil 312 are part of the refrigeration system described further below with respect to FIGS. 4a-4e.

Ambient air entering through air inlet 34 and air filter 308 first passes through pre-cooler evaporator coil 310, which performs a first stage of cooling, reducing the air temperature before it reaches turbo-blower 240. Turbo-blower 240 compresses the pre-cooled air and discharges it through conical expansion duct 306 into lower duct 302. Conical expansion duct 306 gradually increases in cross-sectional area from the outlet of turbo-blower 240 to the inlet of lower duct 302, converting the dynamic pressure of the high-velocity discharge air into static pressure through controlled deceleration. Air exiting a centrifugal compressor such as turbo-blower 240 travels at a high Mach number and carries significant dynamic pressure. An abrupt change in duct geometry at the compressor outlet would cause the dynamic pressure to be lost as heat rather than recovered as useful static pressure. Conical expansion duct 306 avoids this loss by providing a gradual increase in cross-sectional area, allowing the air to decelerate smoothly and recover static pressure, resulting in an output pressure of at least 6 psig at the design mass flow of 100 pounds per minute. Turbo-blower 240 is capable of producing output pressures of up to 8 psig, with a design operating point of 6 psig at 100 pounds per minute mass flow. The compressed, pre-cooled air then passes through post-cooler evaporator coil 312 in lower duct 302, which performs a second stage of cooling to achieve the final desired outlet temperature of approximately 45 degrees Fahrenheit before exiting through air outlet 36.

Turbo-blower oil cooler radiator 246 is disposed within an opening in upper duct 300 below pre-cooler evaporator coil 310. Cooling fan 248 pushes air through turbo-blower oil cooler radiator 246, cooling the oil circulating through the motor and bearing assemblies of turbo-blower 240. The air blown by cooling fan 248 is air that has passed through air filter 308 but has not yet passed through pre-cooler evaporator coil 310. Air pushed through turbo-blower oil cooler radiator 246 by cooling fan 248 is exhausted into the interior of air conditioning section 30 and out to ambient, separate from the main conditioned air stream. This arrangement allows turbo-blower oil cooler radiator 246 to share the filtered air intake of air conditioning section 30 without requiring a separate dedicated air filter or inlet for the turbo-blower cooling circuit, reducing complexity and component count.

FIG. 3e is a top-down view of ground support system 10 with the roof panel removed, showing the spatial arrangement of air conditioning section 30 and electrical generation section 20. Condenser fan 32 is visible in the lower-left portion of the figure. The duct system comprising upper duct 300 and lower duct 302 occupies the upper-middle portion of the figure, with pre-cooler evaporator coil 310 and turbo-blower 240 visible within the upper duct. Electrical generation section 20 occupies the right third of the figure.

FIG. 3e illustrates how turbo-blower 240, by virtue of fitting entirely within upper duct 300, occupies essentially no additional floor space within the single-pallet footprint of ground support system 10. In prior ground support systems, the motor and mechanical drive train for the air conditioning blower occupied approximately one-quarter of the two-pallet footprint. By replacing the conventional motor and drive train with turbo-blower 240, which fits within the ductwork itself, this footprint is entirely eliminated, contributing substantially to the ability of ground support system 10 to fit within a single 463 L pallet.

FIGS. 4a-4e illustrate the refrigeration system of air conditioning section 30. FIGS. 4a and 4b show a first embodiment of the refrigeration system employing a conventional refrigerant compressor. FIG. 4a is a rear-right perspective view of air conditioning section 30 with condenser coils 38 swung open to reveal the interior of the refrigeration compartment, and FIG. 4b is a top-down view of the same embodiment.

Conventional compressor 400 in FIGS. 4a and 4b is an electrically driven screw-type or scroll-type compressor rated at 80 horsepower in one embodiment. Conventional compressor 400 is mounted on the floor of the refrigeration compartment within air conditioning section 30. A refrigerant receiver 402 is disposed adjacent to conventional compressor 400 and stores liquid refrigerant for the system. A refrigerant accumulator 404 is disposed within the refrigeration compartment and protects conventional compressor 400 by ensuring only vapor-phase refrigerant enters the compressor inlet. A condenser fan motor 406 is mounted above the refrigeration compartment and drives condenser fan 32 to move air through condenser coils 38. As shown in the top-down view of FIG. 4b, conventional compressor 400 occupies a substantial portion of the floor area of the refrigeration compartment within air conditioning section 30.

FIGS. 4c and 4d illustrate the refrigeration system in a second embodiment employing two turbo-refrigerant compressors 410a and 410b arranged in series in place of conventional compressor 400. Turbo-refrigerant compressors 410a and 410b are compact units mounted on the back wall of the refrigeration compartment, each driven by a respective direct-drive electric motor 412a or 412b mounted on the same shaft as the compressor wheel and operating at 60,000 rpm. In other embodiments, compressors 410a and 410b operate at between 20,000 rpm and 80,000 rpm. Each turbo-refrigerant compressor 410 is approximately 12 inches in length and 8 inches in diameter, and the pair together represent a reduction of 90% in weight and 95% in volume compared to conventional compressor 400.

The direct-drive motor-on-shaft configuration eliminates the gearbox required by prior turbo-compressor designs, reducing complexity and maintenance requirements. As shown in the top-down view of FIG. 4d, replacing conventional compressor 400 with turbo-refrigerant compressors 410a and 410b mounted on the back wall frees substantially all of the floor area previously occupied by conventional compressor 400, providing space for additional subsystems and features within the single-pallet footprint of ground support system 10, such as the PAO liquid cooling system and self-propelled drive system described further below.

FIG. 4e is a schematic block diagram of the refrigerant circuit of the second embodiment. The circuit comprises a main refrigerant loop and a separate bearing lubrication circuit. In the main refrigerant loop, high-pressure vapor refrigerant discharged from the compressor stages passes through condenser coils 38, where condenser fan 32 rejects heat to ambient air and condenses the refrigerant to a high-pressure liquid. The liquid refrigerant is collected in receiver 402 and then passes through expansion devices 422 and 423, which reduce the refrigerant pressure and temperature going into pre-cool evaporator 310 and post-cool evaporator 312, respectively. The low-pressure, low-temperature refrigerant then passes through evaporators 310 and 312 in parallel, where it absorbs heat from the conditioned air stream and vaporizes. The low-pressure vapor then passes through accumulator 404, which ensures only vapor-phase refrigerant enters the compressor stages by separating any remaining liquid refrigerant.

The vapor then enters first-stage turbo-refrigerant compressor 410a, driven by direct-drive motor 412a, where it is compressed to an intermediate pressure. The partially compressed vapor discharged from first-stage turbo-refrigerant compressor 410a passes directly to the inlet of second-stage turbo-refrigerant compressor 410b, where it is compressed to full condensing pressure before returning to condenser coils 38 to complete the main refrigerant loop. Additional techniques to improve refrigeration cycle performance are used in conjunction with compressors 410a and 410b in other embodiments, such as providing interstage cooling or an economizer function.

The bearing lubrication circuit is a separate circuit that provides lubrication to the high-speed bearings of turbo-refrigerant compressors 410a and 410b. The bearing lubrication circuit comprises a dedicated lubrication accumulator 424, a lubrication pump 426, and a shut-off valve 428, which together supply lubricant at controlled pressure to differential pressure regulators 430a and 430b. Differential pressure regulator 430a controls bearing lubrication flow to first-stage turbo-refrigerant compressor 410a and differential pressure regulator 430b controls bearing lubrication flow to second-stage turbo-refrigerant compressor 410b, with each regulator maintaining bearing flow at a pressure differential appropriate to the operating conditions of its respective compressor stage. The bearing lubrication circuit uses refrigerant drawn from the main refrigerant loop as the lubricant, eliminating the need for a separate oil lubrication system and simplifying the overall system architecture. In one embodiment, the compressors 410a and 410b operate oil-free, using only the liquid refrigerant to supply pressurized journal bearings on the motor/compressor shaft.

Turbo-refrigerant compressors 410a and 410b are independently driven by separate direct-drive motors 412a and 412b as shown in FIG. 4e, allowing each stage to be independently characterized and controlled. In another embodiment, both compressor wheels of turbo-refrigerant compressors 410a and 410b are mounted on a common shaft driven by a single motor, simplifying the mechanical arrangement and reducing component count. The optimal configuration is determined based on system testing and performance characterization. In one embodiment, turbo-compressors 410a and 410b can be re-configured to operate in either series or parallel, depending on the operating conditions and required compression ratio. If only a low compression ratio is needed, then the stages may work in parallel to supply more refrigerant flow and increase the capacity of the system, such as needed for cooler, humid climates versus higher pressure ratio for dry, hotter climates.

The refrigerant circuit of FIG. 4e is also applicable to the first embodiment employing conventional compressor 400 in place of turbo-refrigerant compressors 410a and 410b, with the two compressor stages replaced by a single conventional compressor 400 and the bearing lubrication circuit omitted. In the first embodiment, conventional compressor 400 employs a dedicated oil lubrication system integral to the compressor, which may optionally include a separate oil cooler. In an alternative embodiment, a single turbo-refrigerant compressor stage may be used in place of the two-stage configuration, with the bearing lubrication circuit serving the single stage. In another embodiment, one or more scrolls or other conventional refrigerant compressors may be used.

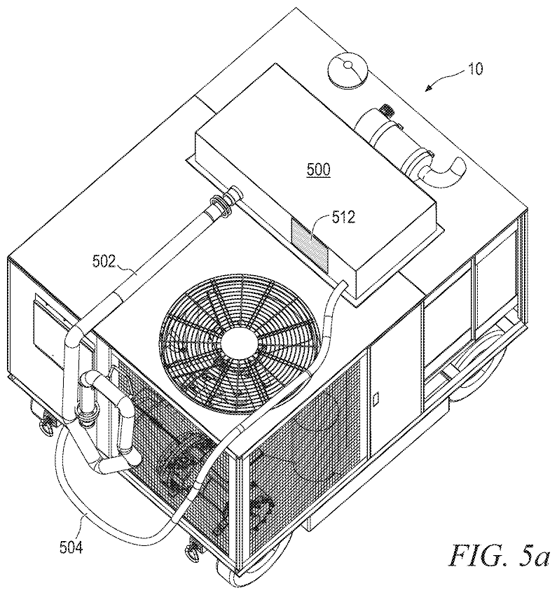

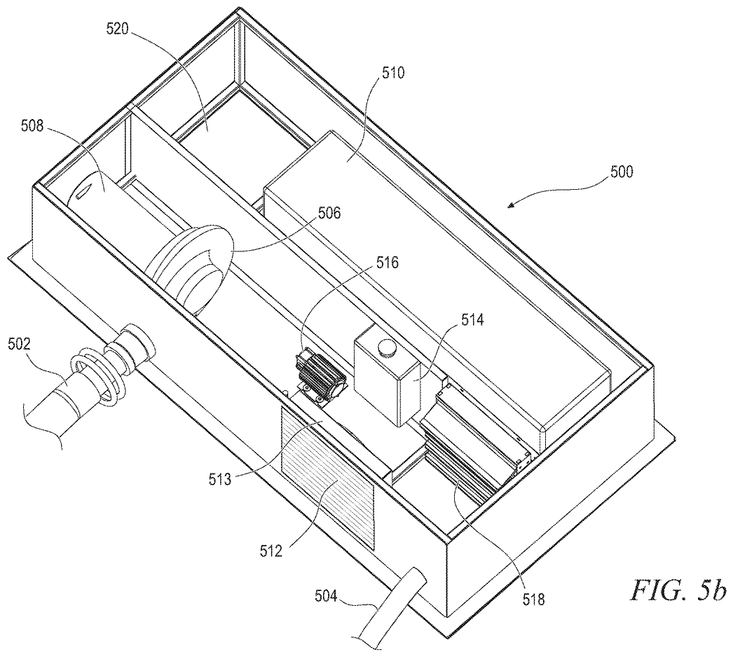

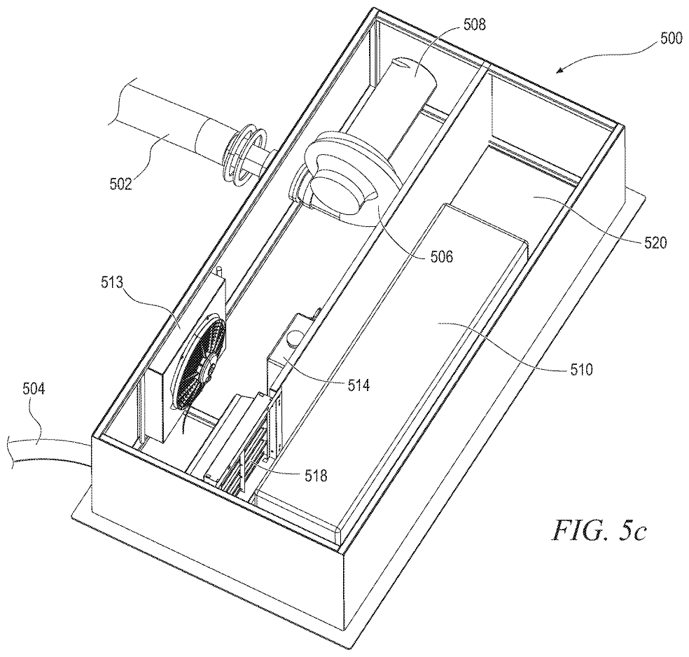

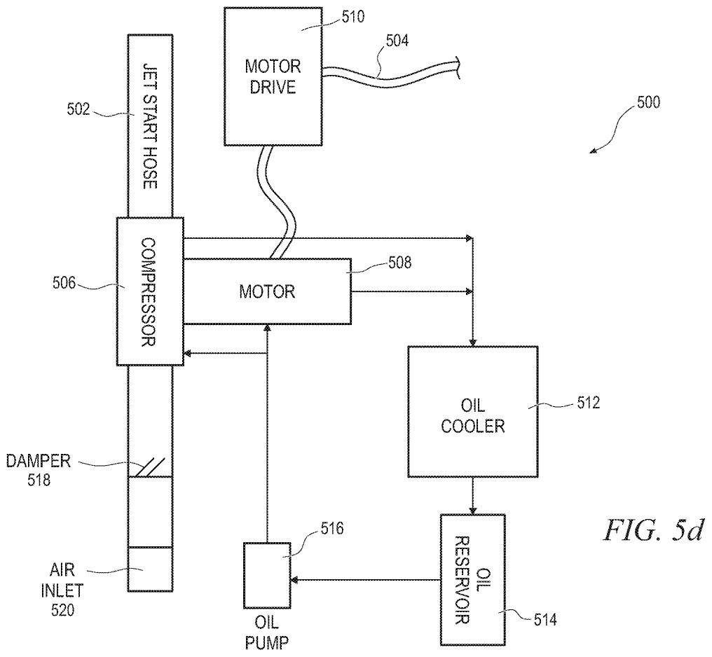

FIGS. 5a-5d illustrate an optional electric bleed air module 500 that may be installed on ground support system 10. Bleed air refers to compressed air delivered to an aircraft at a pressure of two to ten times ambient atmospheric pressure and at sufficient mass flow to drive the aircraft's onboard environmental control system or to provide sufficient pressure and flow to start an engine aboard the aircraft. Military aircraft use bleed air from a ground source to operate their onboard air cycle machines, which use the energy of the compressed air to cool the air before it is distributed to the aircraft cabin and avionics bays. This allows the aircraft's cooling system to be tested and operated on the ground without running the aircraft engines. Additionally, most military aircraft engines include an air turbine starter that uses high-pressure bleed air to spin the engine up to starting speed, providing an alternative to the aircraft's auxiliary power unit for engine starting.

Electric bleed air module 500 is a self-contained, roof-mounted module that bolts onto the roof of ground support system 10 and plugs into 700 VDC bus 222 to receive electrical power. Electric bleed air module 500 may also be mounted on prior art two-pallet ground support systems or other ground support equipment having a suitable electrical power supply, as the module is self-contained and requires only an electrical power connection. In one embodiment, electric bleed air module 500 is also operable as a standalone unit by connecting to 480 VAC three-phase facility power in a hangar environment, independent of any trailer. Electric bleed air module 500 occupies a volume of 6 feet long by 3 feet wide by 1.5 feet tall on the trailer roof and weighs 300 pounds. When installed on ground support system 10, the combined height remains within the 8-foot height limit for C-130 air transport.

FIG. 5a shows electric bleed air module 500 installed on the roof of ground support system 10 with its cover in place. A jet start hose 502 is connected to the bleed air outlet of electric bleed air module 500 and hangs free, ready for connection to an aircraft bleed air inlet. An electrical cable 504 routes from electric bleed air module 500 down the exterior of ground support system 10 and connects to 700 VDC bus 222 beneath the trailer. Electric bleed air module 500 is secured to the roof of ground support system 10 by mechanical fasteners, and a removable roof panel beneath the module allows electric bleed air module 500 to draw air upward from within air conditioning section 30, sharing the 24-inch by 24-inch air filter 308 already installed in the trailer. When electric bleed air module 500 is installed, the filtered air that would otherwise flow through the air conditioning duct system is instead drawn upward into the compressor inlet of electric bleed air module 500 and discharged through jet start hose 502 rather than through air outlet 36.

FIGS. 5b and 5c show electric bleed air module 500 with its cover removed to reveal the internal components, from two different angles. FIG. 5b shows the module from a top-front perspective and FIG. 5c shows the module in isolation from a top-rear perspective, together providing a complete view of all internal components. Electric bleed air module 500 contains a bleed air compressor 506, a direct-drive bleed air motor 508, a motor drive 510, an oil cooler 512, an oil reservoir 514, an oil pump 516, and a backdraft damper 518, all within a compact rectangular housing. An air inlet 520 is formed in the base of electric bleed air module 500 and interfaces with the removable roof panel of ground support system 10 to admit filtered air drawn up from within the trailer.

Bleed air compressor 506 is a centrifugal compressor driven by bleed air motor 508, a direct-drive electric motor mounted on the same shaft as the compressor wheel and operating at 50,000 rpm. In other embodiments, bleed air compressor 506 operates at between 25,000 rpm and 75,000 rpm. Bleed air motor 508 is rated at 200 horsepower for continuous operation and is powered by motor drive 510, which is a variable frequency drive rated at 350 horsepower but derated to 200 horsepower for operation at ambient temperatures up to 50 degrees Celsius. Motor drive 510 receives power from 700 VDC bus 222 via electrical cable 504 and controls the speed of bleed air motor 508 to regulate compressor output pressure and flow. In one embodiment, bleed air compressor 506 includes variable guide vanes to further modulate output flow across a range of operating conditions.

The motor and compressor bearings of electric bleed air module 500 are cooled and lubricated by a dedicated oil circuit comprising oil reservoir 514, oil pump 516, and oil cooler 512. Oil pump 516 circulates oil under pressure from oil reservoir 514 through bleed air motor 508 and bleed air compressor 506, providing both lubrication and cooling of the motor windings and compressor bearings. In one embodiment, the motor jacket cooling and bearing lubrication are served by the same oil circuit, eliminating the need for a separate water-cooling loop for the motor jacket. The heated oil is returned through oil cooler 512, which is disposed in an opening in a sidewall of electric bleed air module 500. Oil cooler 512 has a dedicated cooling fan 513 that draws a small portion of the filtered inlet air through the oil cooler radiator core and exhausts it outward to ambient through the sidewall opening, providing cooling airflow for the oil circuit without recirculating heated air back into the main compressed air stream. Other embodiments may use non-lubricated bearings, such as foil, air, or magnetic bearings. Use of non-lubricated bearings may not eliminate the need for liquid cooling for the motor jacket.

Backdraft damper 518 is disposed in the air flow path between air inlet 520 and the inlet of bleed air compressor 506. Backdraft damper 518 prevents air from flowing back through air inlet 520 when electric bleed air module 500 is not operating. In one embodiment, backdraft damper 518 is a passive check valve that opens under the suction of bleed air compressor 506 and closes when the compressor stops. Other embodiments omit backdraft damper 518.

FIG. 5d is a block diagram showing the connections between the components of electric bleed air module 500. Air enters through air inlet 520, passes through backdraft damper 518, and is compressed by bleed air compressor 506, which is driven by bleed air motor 508. The compressed air exits through jet start hose 502 at 100 pounds per minute and 35 psig in continuous operation, or 120 pounds per minute at 40-45 psig for up to two minutes during an engine air start. The pounds per minute and psig numbers can be different in other embodiments. Motor drive 510 receives electrical power from 700 VDC bus 222 via power cord 504 and drives bleed air motor 508. The oil circuit comprising oil reservoir 514, oil pump 516, and oil cooler 512 circulates oil through bleed air motor 508 for cooling and lubrication. A communication link between electric bleed air module 500 and the ground support system 10 allows the operator to control the electric bleed air module 500 from the user interface 37.

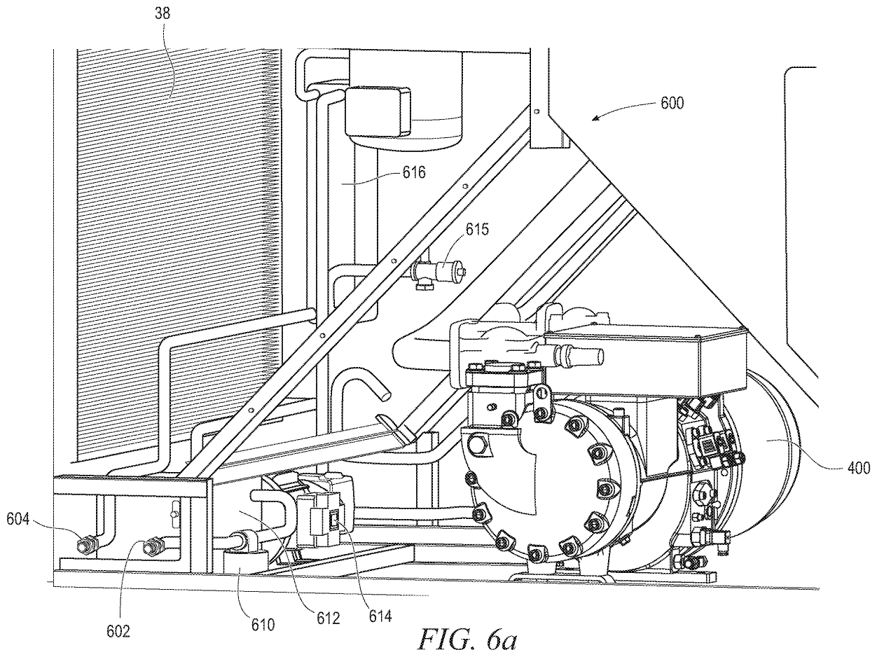

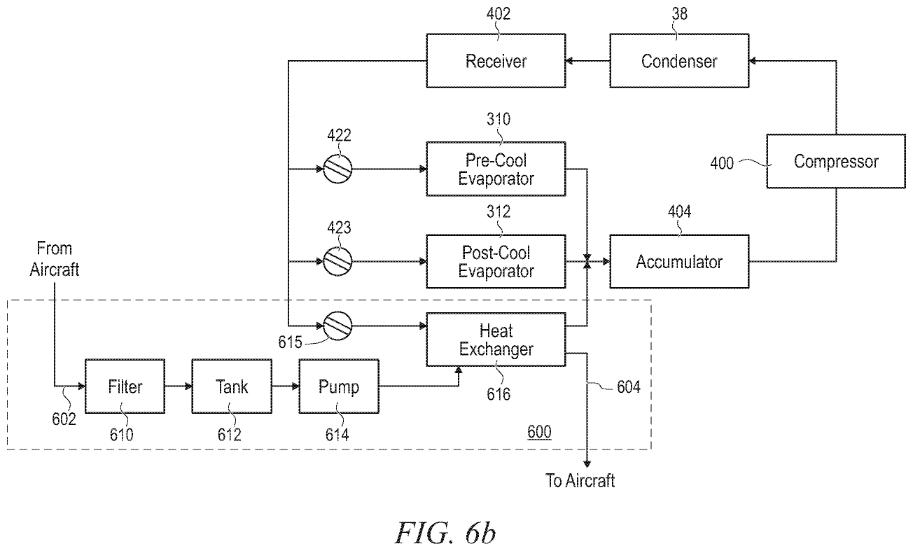

FIGS. 6a and 6b illustrate an optional polyalphaolefin (PAO) liquid cooling system 600 that may be installed within ground support system 10. Modern military aircraft cool high power-density avionics, radar systems, and power electronics using closed-loop liquid cooling circuits circulating PAO fluid. PAO fluid is used in these applications because of its excellent thermal stability, wide operating temperature range, dielectric properties, low toxicity, and compatibility with aircraft materials. As avionics power densities continue to increase, air cooling alone is insufficient to maintain avionics within operating temperature limits, and ground-based PAO cooling capability is an increasingly critical requirement for flight-line ground support equipment.

PAO liquid cooling system 600 can be installed at a back end of ground support system 10 by moving compressor 400 out of the way as illustrated, or the PAO liquid cooling system parts can be positioned around the compressor in its previously illustrated position. Alternatively, the floor space freed within air conditioning section 30 by replacing conventional compressor 400 with the compact turbo-refrigerant compressors 410a and 410b, as described above with respect to FIGS. 4c-4d, provides more to accommodate PAO liquid cooling system 600 within the existing single-pallet footprint of ground support system 10. In an alternative embodiment, PAO liquid cooling system 600 is housed within the underframe compartment accessible through access door 40 beneath air conditioning section 30. In other embodiments, PAO liquid cooling system 600 can be installed into any compartment of ground support system 10.

FIG. 6b is a block diagram showing how PAO liquid cooling system 600 integrates with the refrigeration circuit of air conditioning section 30. PAO liquid cooling system 600 receives PAO coolant from an aircraft via inlet 602. The incoming PAO coolant is routed through a filter 610 and into a tank 612. A pump 614 pulls PAO coolant from tank 612 and pushes the coolant through a heat exchanger 616. Heat exchanger 616 operates in parallel with pre-cool evaporator 310 and post-cool evaporator 312 and has its own expansion device 615 for the incoming coolant from the main cooling loop. The chilled PAO coolant is returned to the aircraft via outlet 604.

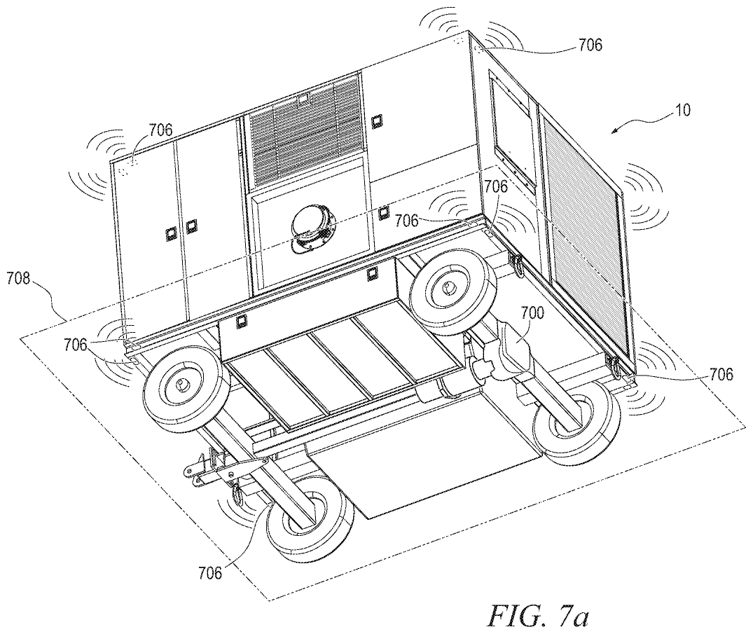

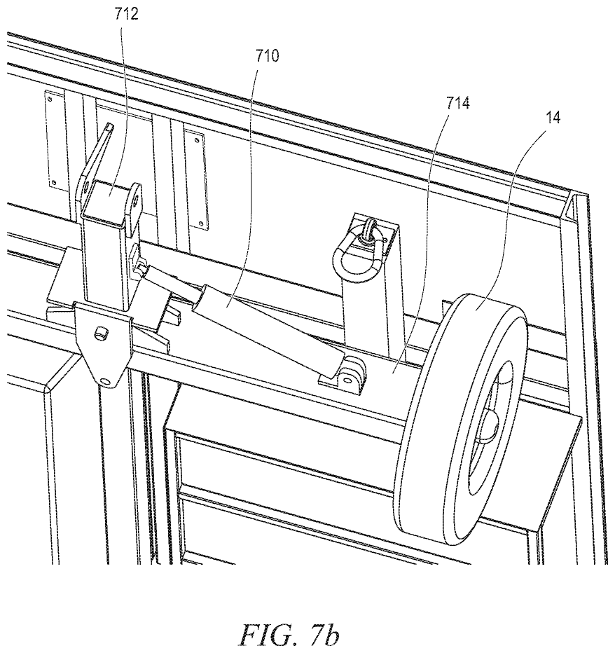

FIG. 7a is a perspective view of the underside of ground support system 10 showing an optional self-propelled drive system 700 for ground support system 10. Self-propelled drive system 700 includes a drive motor and gearbox assembly mounted on the rear axle of trailer frame 12 between rear wheels 14. A drive battery can be mounted in the refrigeration compartment under condenser fan 32 as illustrated for PAO liquid cooling system 600. Self-propelled drive system 700 allows ground support system 10 to move under its own power without requiring a towing vehicle, reducing the manpower and logistical burden of repositioning ground support equipment on the flight line. Like PAO liquid cooling system 600, self-propelled drive system 700 fits within the existing single-pallet footprint of ground support system 10 without any increase in trailer size. In some embodiments, ground support system 10 includes both PAO liquid cooling system 600 and also self-propelled drive system 700, again without any increase in trailer size.

The drive motor and gearbox assembly is an electrically driven axle drive unit powered from 700 VDC bus 222 via a motor drive controller. In one embodiment, the drive motor and gearbox assembly employs a compact electric drive motor coupled to the rear axle through a reduction gearbox. The drive battery is a hybrid battery pack in one embodiment, comprising a nickel metal hydride or lithium-ion battery with a weight of approximately 160 pounds and sufficient energy storage to provide a range of two miles of self-propelled travel. The drive battery is charged from 700 VDC bus 222 during normal operation of ground support system 10.

FIG. 7b is a perspective view of the underside of the front of ground support system 10 showing a steering actuator 710 for self-propelled drive system 700. Steering actuator 710 is coupled between a front tongue 712 of trailer frame 12 and a front axle 714. Front axle 714 is rotatably mounted to front tongue 712, allowing the axle to pivot relative to the longitudinal axis of the trailer. Steering actuator 710 comprises an electrically controlled linear actuator that pushes and pulls front axle 714 to effect directional changes during self-propelled operation.

Self-propelled drive system 700 includes proximity and acoustic sensors 706 distributed around the perimeter of trailer frame 12 to provide collision avoidance. In one embodiment, sixteen acoustic sensors 706 are arranged around the trailer perimeter, two on each top corner and two on each bottom corner, creating a virtual safety bumper 708. When a sensor 706 detects an obstacle within a first threshold distance, ground support system 10 emits a warning. When an obstacle is detected within a second, closer threshold distance, ground support system 10 automatically ceases movement to prevent collision with aircraft, ground crew, or other equipment. A manual override allows the operator to direct movement closer than the second threshold distance when required for precise aircraft connection.

Ground support system 10 may be operated in multiple self-propelled modes. In a manual mode, an operator walks alongside ground support system 10 and controls its movement using a handheld controller tethered to the trailer by a cable or communicating wirelessly. The operator directs speed via the drive motor and steering via steering actuator 710, allowing precise manual positioning of ground support system 10 relative to an aircraft or other target location. Collision avoidance sensors 706 remain active during manual operation to prevent the operator from inadvertently commanding a collision.

In an autonomous mode, ground support system 10 operates without an operator walking alongside. Flight line movement paths between hangars, parking areas, and aircraft positions are pre-programmed into a control system of ground support system 10. Ground support system 10 uses GPS guidance to navigate between pre-programmed positions, with the control system automatically commanding steering actuator 710 and the drive motor to follow the designated path. An operator can command ground support system 10 to autonomously travel from its current position to a specified destination, such as from hangar five to hangar ten, without requiring an operator to walk alongside. Collision avoidance sensors 706 remain active during autonomous operation. In one embodiment, ground support system 10 is also capable of autonomously loading and unloading itself from a transport vehicle or cargo aircraft ramp. Additional sensor technology, such as radar, laser, or vision systems, may be employed alone or in combination to accomplish autonomous motion.

The integration of steering actuator 710 with the rear-mounted drive motor and gearbox assembly allows ground support system 10 to execute both manual and autonomous maneuvering within the compact single-pallet footprint, providing full mobility without increasing the trailer size beyond the standard 463 L pallet envelope.

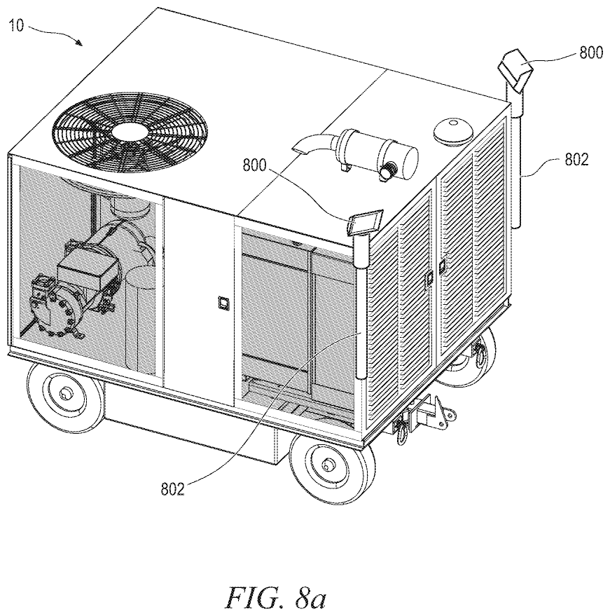

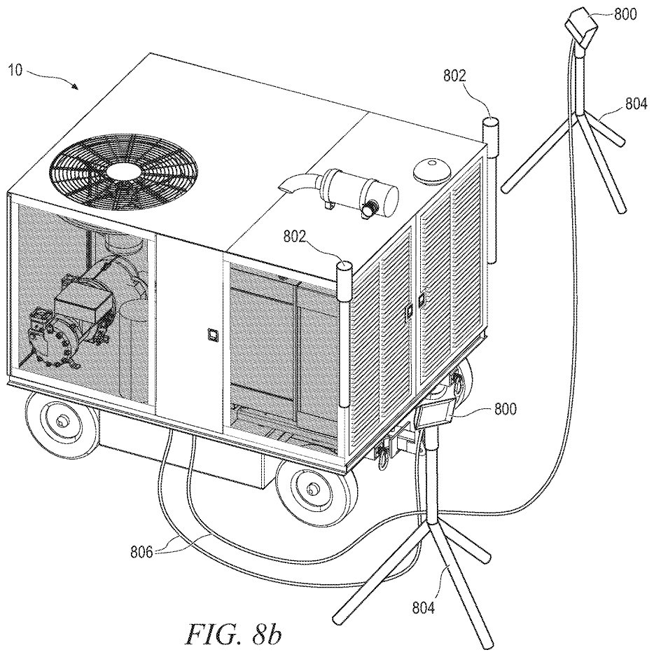

FIGS. 8a and 8b illustrate an optional area lighting system for ground support system 10. The lighting system comprises a plurality of flood light units 800 and a corresponding plurality of stanchions 802 mounted at corners of ground support system 10 on the electrical generation section end of the trailer. In one embodiment, two flood light units 800 are provided, one at each of two corners of trailer frame 12. In another embodiment, four flood light units 800 are provided, one at each corner of trailer frame 12. Each stanchion 802 is a cylindrical receptacle fixed to trailer frame 12 into which flood light unit 800 is inserted and secured for transport and trailer-mounted operation. In the trailer-mounted configuration shown in FIG. 8a, flood light units 800 are seated in stanchions 802 and oriented to illuminate the immediate work area around ground support system 10, providing lighting for flight-line personnel performing aircraft servicing operations in low-light or night-time conditions.

As shown in FIG. 8b, flood light units 800 are removed from stanchions 802 and each include an integrated collapsible tripod 804 that allows the light to be deployed as a freestanding area light at any desired location on the flight line. Each flood light unit 800 is connected to ground support system 10 by a power cord 806 of sufficient length to allow placement at a distance from the trailer. In one embodiment, power cord 806 is 25 feet in length, allowing flood light units 800 to be positioned to illuminate areas not directly adjacent to ground support system 10. Flood light units 800 are powered from 700 VDC bus 222 via an appropriate power converter during normal operation of ground support system 10. In another embodiment, flood light units 800 are powered from the drive battery, used for self-propelled modes described above for FIG. 7, for up to eight hours after engine 200 has been shut down, allowing the flight line work area to remain illuminated after ground support system 10 has completed its servicing mission and the engine has been turned off.

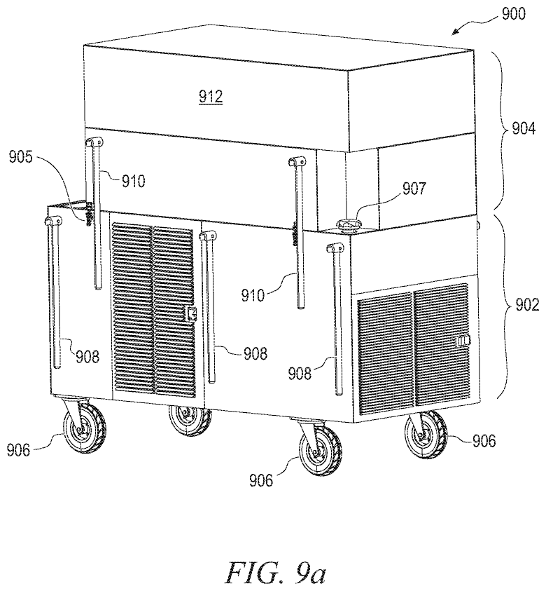

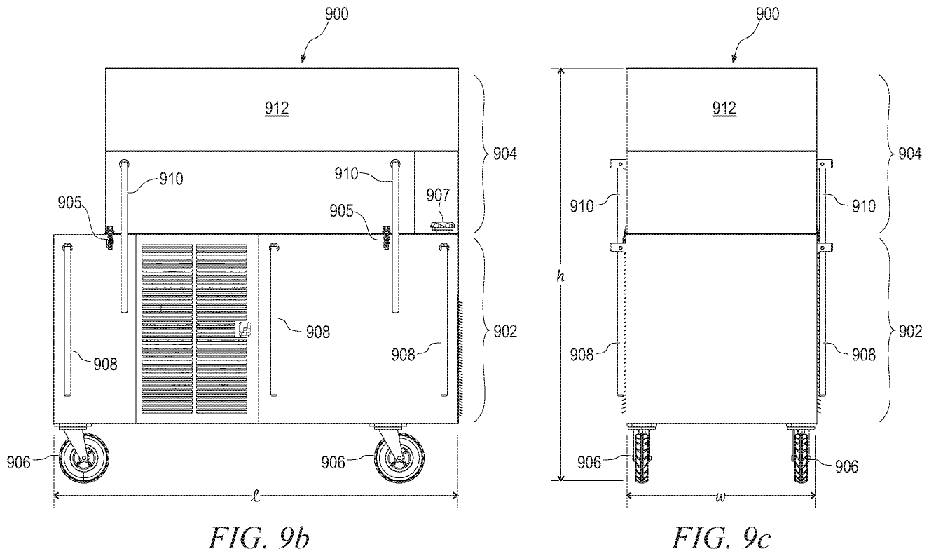

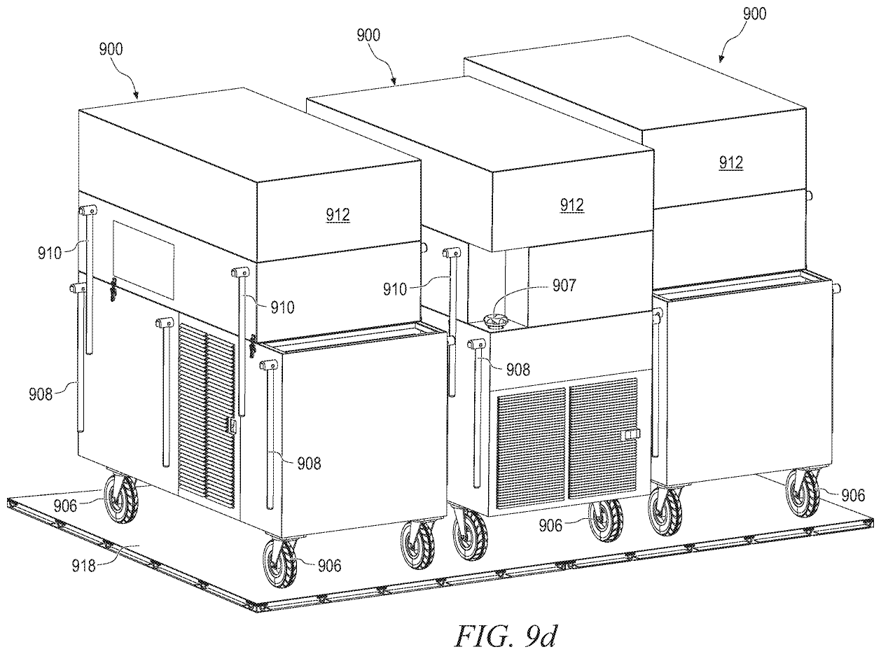

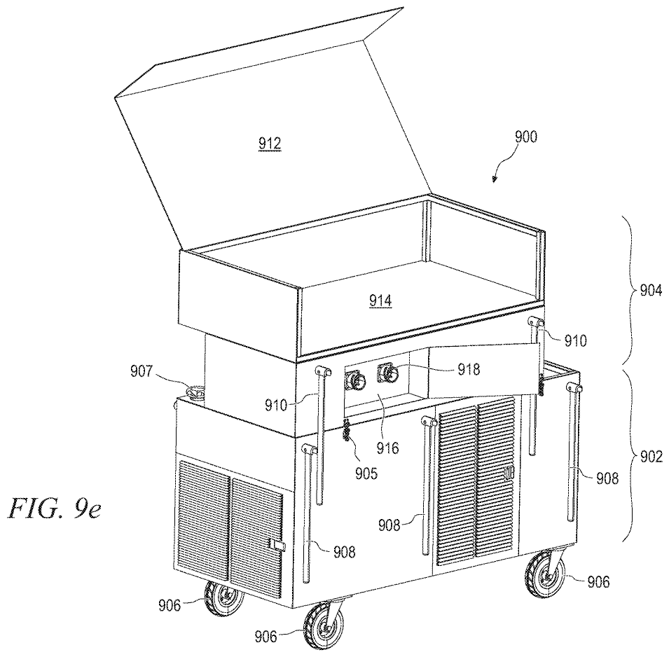

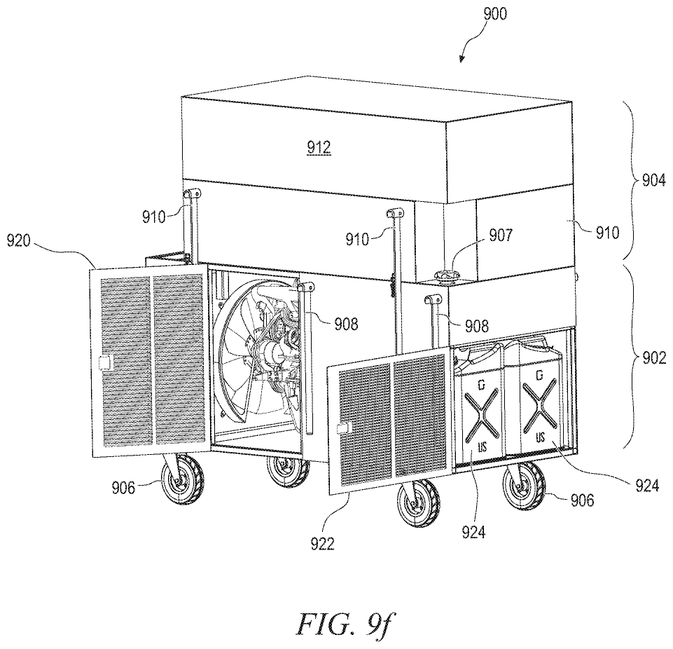

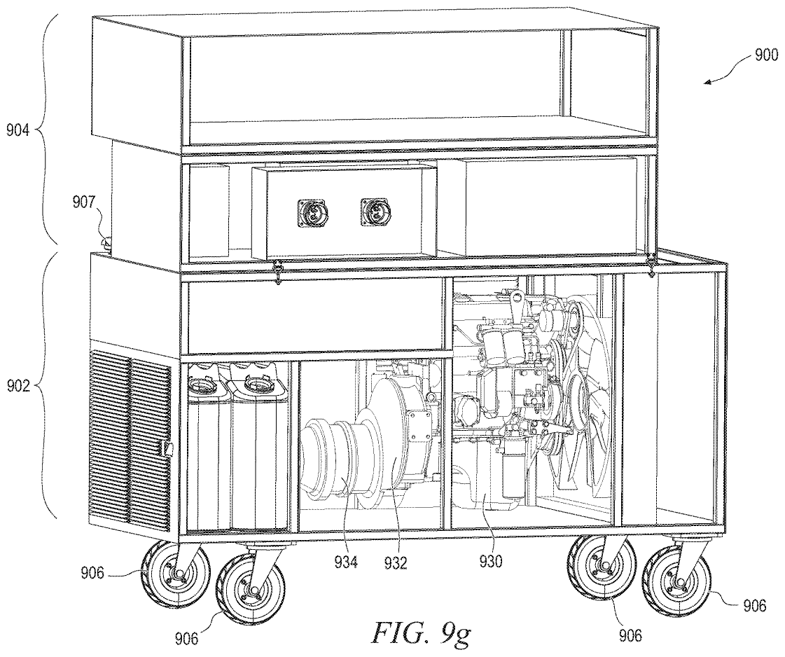

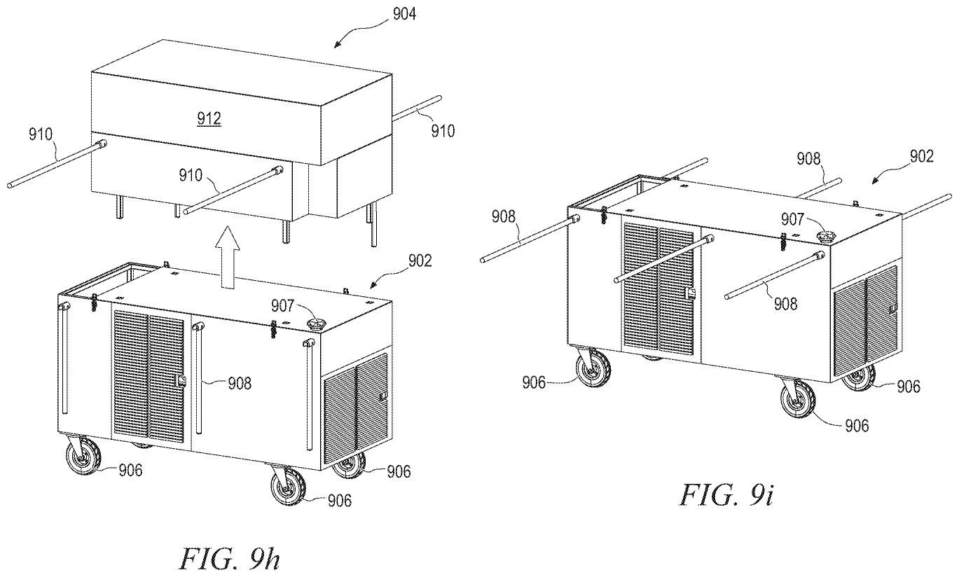

FIGS. 9a-9i illustrate a compact, man-portable power unit 900. Power unit 900 is a lightweight, self-contained electrical generator designed for portability and rapid deployment. Power unit 900 employs a high-speed diesel engine driving a step-up gearbox and a compact aircraft-type generator to produce electrical power at multiple voltages and frequencies required by military aircraft and base operations, packaged in a form factor that can be transported by a small team of personnel without mechanical lifting equipment. In one embodiment, power unit 900 produces 60 kilowatts of electrical output and provides aircraft power at 400 Hz AC and 270 VDC, as well as utility power at 208 VAC, 60 Hz, three-phase for base operations. Power unit 900 produces 60 kilowatts of electrical output, though other embodiments may produce more or less electrical output depending on the engine and generator selected, e.g., between 50 and 70 kilowatts.

Estimated fuel consumption is approximately 4 gallons per hour. By comparison, the standard military MEP806B battlefield genset of comparable output weighs 3,556 pounds dry. Power unit 900 has a total assembled weight of 720 pounds dry, representing a reduction of approximately 80 percent in weight compared to the MEP806B, while providing superior electrical output capability. Power unit 900 is sized so that three complete units fit within the footprint of a single standard 463 L military airlift pallet, as shown in FIG. 9d, allowing three independent 60-kilowatt power sources to be transported in the same airlift space as a single conventional ground support genset.

FIG. 9a is a perspective view of power unit 900 in its fully assembled configuration. FIG. 9b is a side elevation view of power unit 900. FIG. 9c is an end elevation view of power unit 900. FIGS. 9b and 9c show that power unit 900 has a height h of 66 inches, a width w of 34 inches, and a length l of 64 inches. Power unit 900 comprises a lower genset module 902 and an upper electronics module 904 that together form the complete assembled unit. Lower genset module 902 houses the engine, gearbox, generator, and fuel system, and upper electronics module 904 houses the power electronics, inverters, converters, and electrical output connections. Lower genset module 902 and upper electronics module 904 are secured together by latches 905 and connected by two electrical plugs that provide the complete electrical interface between the modules, allowing the two modules to be quickly separated for man-portable transport as described further below.

Lower genset module 902 is supported on a plurality of wheels 906, which are caster-type wheels allowing the assembled unit to be rolled on flat surfaces. A fuel filler cap 907 is disposed on the top surface of lower genset module 902, providing access to an onboard fuel tank within lower genset module 902. In one embodiment, the onboard fuel tank holds 20 gallons, which remains empty during transport and is filled on location. An auxiliary fuel pump allows fuel to be transferred from an external fuel bladder to the onboard fuel tank. Carry bars 908 are disposed vertically along the sides of lower genset module 902 in a stowed position during wheeled transport and storage and carry bars 910 are similarly disposed vertically along the sides of upper electronics module 904. Carry bars 908 and 910 pivot outward to a horizontal carrying position when the respective modules are to be man-carried as described further below with respect to FIGS. 9h and 9i.

FIG. 9d illustrates three units of power unit 900 stowed together on a single standard 463 L pallet 18. The compact footprint of power unit 900 allows three complete units to fit within the 104-inch by 84-inch usable area of a single 463L pallet, enabling three independent 60-kilowatt power sources to be transported in the same airlift space otherwise required for a single conventional battlefield genset.

FIG. 9e illustrates power unit 900 with upper electronics module 904 open. Upper electronics module 904 includes a hinged lid 912 that opens upward to reveal a storage compartment 914 within upper electronics module 904, which may be used to store power cables, accessories, and other equipment during transport. On the front face of upper genset module 904, an electrical output panel 916 is accessible through a hinged access door and includes electrical output connectors 918 through which power cables connect to loads or aircraft. In one embodiment, electrical output connectors 918 include connections for 400 Hz AC aircraft power, 270 VDC aircraft power, and 208 VAC utility power. Upper electronics module 904 includes internal components equivalent to, e.g., 400 Hz module 230 and 270 VDC module 234 above.

FIG. 9f illustrates power unit 900 with left louvered door 920 and right louvered door 922 open. Left louvered door 920 opens to reveal the engine compartment containing the engine, radiator, and cooling fan of lower genset module 902. Rear louvered door 922 opens to reveal a fuel can storage compartment 924 configured to store a plurality of military fuel cans. In one embodiment, fuel can storage compartment 924 accommodates two or four standard military fuel cans, which can be transported full and emptied into the onboard fuel tank on location, providing additional fuel range beyond the onboard tank capacity.

FIG. 9g illustrates the interior of power unit 900 in detail with exterior panels removed, showing the internal components of both lower genset module 902 and upper electronics module 904. Lower genset module 902 contains engine 930, gearbox 932, and generator 934. Engine 930 is a diesel engine operating at 3,500 rpm in one embodiment. In one embodiment, engine 930 is a 1.4-liter diesel engine modified to produce 100 to 120 horsepower and weighs approximately 240 pounds due to its aluminum engine block. Any other suitable combustion engine is used in other embodiments to generate output power, and the engine operating speed is selected based on the power output requirements and engine characteristics.

Gearbox 932 is a step-up gearbox that steps up the output shaft speed of engine 930 to 12,000 rpm to drive generator 934 at the speed required for efficient power generation. In other embodiments, gearbox 932 steps up the output shaft speed to between 16,000 and 24,000 rpm. Generator 934 is a compact, high-speed aircraft-type generator rated at 90 kVA. In other embodiments, generator 934 is rated at between 80 and 100 kVA. In another embodiment, generator 934 is rated at 30 kVA or greater. In one embodiment, generator 934 is the same generator used on existing commercial aircraft systems, providing a proven, low-risk design with established service.

The compact size and light weight of generator 934, made possible by its high operating speed, is a key enabler of the man-portable form factor of power unit 900. Upper electronics module 904 contains power electronics including a rectifier that converts the AC output of generator 934 to a high-voltage DC bus, and inverters and converters that produce the 400 Hz AC, 270 VDC, and 208 VAC output signals of power unit 900. In some embodiments, power unit 900 utilizes a 700 VDC bus as illustrated above for ground support system 10, with at least a 500-volt DC rail. Two electrical connectors provide the electrical interface between upper electronics module 904 and lower genset module 902.

FIGS. 9h and 9i together illustrate the man-portable transport capability of power unit 900. Upper electronics module 904 and lower genset module 902 are separated by unlatching the modules from each other via latches 905, after which each module can be independently man-carried. As shown in FIG. 9h, carry bars 910 of upper electronics module 904 are pivoted outward to a horizontal carrying position, allowing personnel to carry upper electronics module 904 by gripping carry bars 910 on each side. In one embodiment, upper electronics module 904 weighs 250 pounds and is carried by four personnel using carry bars 910.

As shown in FIG. 9i, carry bars 908 of lower genset module 902 are similarly pivoted outward to a horizontal carrying position, allowing personnel to carry lower genset module 902 by gripping carry bars 908 on each side. In one embodiment, lower genset module 902 weighs 350 pounds and is carried by four to six personnel using carry bars 908. By separating power unit 900 into upper electronics module 904 and lower genset module 902 for transport, each section is within the carrying capacity of a small team of personnel without mechanical lifting equipment, allowing power unit 900 to be transported and deployed in environments where vehicles and material handling equipment may not be available. The two modules are reassembled by placing upper electronics module 904 onto lower genset module 902 and securing latches 905, after which power unit 900 is ready for operation.

While one or more embodiments of the present invention have been illustrated in detail, the skilled artisan will appreciate that modifications and adaptations to those embodiments may be made without departing from the scope of the present invention as set forth in the following claims. The specific values, dimensions, speeds, pressures, flow rates, temperatures, weights, and other numerical parameters recited herein are intended to describe particular embodiments and are not intended to be limiting. Such values represent nominal or target design parameters, and actual values in any particular embodiment may vary from the stated values due to manufacturing tolerances, operating conditions, component selection, and design optimization. Unless otherwise indicated by the use of limiting language in the claims, such as “exactly” or “at least”, numerical values recited herein should be understood as approximate values representing the general order of magnitude and design intent of the described embodiments.

What is claimed:

1. A ground support system, comprising:
a trailer frame;
an engine disposed on the trailer frame, wherein the engine is oriented transverse to a longitudinal axis of the trailer frame;
a gearbox including an input of the gearbox coupled to an output of the engine, wherein the gearbox steps up a rotational speed of the engine to at least 6,000 rpm at an output of the gearbox;
a generator coupled to the output of the gearbox;
an air duct disposed on the trailer frame including an inlet and an outlet;
a turbo-blower disposed in the air duct, wherein the turbo-blower is configured to be powered by the generator;
a first evaporator coil disposed in the air duct upstream of the turbo-blower; and
a second evaporator coil disposed in the air duct downstream of the turbo-blower.

2. The ground support system of claim 1, further including a rectifier coupled to the generator, wherein no mechanical loads are coupled to the engine other than the gearbox and generator.

3. The ground support system of claim 1, further including a conical expansion duct coupled to an output of the turbo-blower.

4. The ground support system of claim 1, further including a PAO liquid cooling system disposed on the trailer frame.

5. The ground support system of claim 1, further including an electric bleed air module disposed on the trailer frame.

6. The ground support system of claim 1, further including an inverter module disposed on the trailer frame, wherein the inverter module is configured to generate 400 Hz or 270 VDC power.

7. The ground support system of claim 1, further including:
a drive motor attached to the trailer frame; and
a steering actuator attached to the trailer frame.

8. The ground support system of claim 7, wherein the ground support system is configured to operate the drive motor and steering actuator autonomously.

9. The ground support system of claim 1, further including:
a stanchion mounted onto the trailer frame; and
a flood light disposed in the stanchion, wherein the flood light is removable and free-standing.

10. A method of making a ground support system, comprising:
providing a trailer frame;
disposing an engine on the trailer frame, wherein the engine is oriented transverse to a longitudinal axis of the trailer frame;
coupling a generator to the engine, wherein the generator is configured to operate at a speed of at least 6,000 rpm;
disposing an air duct on the trailer frame; and
disposing a turbo-blower in the air duct.

11. The method of claim 10, further including coupling a rectifier to the generator, wherein no additional mechanical loads are coupled to the engine.

12. The method of claim 10, further including coupling a conical expansion duct to an output of the turbo-blower.

13. The method of claim 12, wherein the conical expansion duct extends from a first portion of the air duct to a second portion of the air duct.

14. The method of claim 10, further including disposing a PAO liquid cooling system on the trailer frame.

15. The method of claim 10, further including disposing an electric bleed air module on the trailer frame.

16. The method of claim 10, further including disposing an inverter module on the trailer frame, wherein the inverter module is configured to generate 400 Hz or 270 VDC power.

17. The method of claim 10, further including:
attaching a drive motor to the trailer frame; and
attaching a steering actuator to the trailer frame.

18. The method of claim 17, further including configuring the drive motor and steering actuator to autonomously drive the ground support system.

19. The method of claim 10, further including:
mounting a stanchion onto the trailer frame; and
disposing a flood light in the stanchion, wherein the flood light is removable and free-standing.

20. A power unit, comprising:
a lower genset module including,
an engine,
a gearbox including an input of the gearbox coupled to an output of the engine, wherein the gearbox steps up a rotational speed of the engine to at least 6,000 rpm at an output of the gearbox, and
a generator coupled to the output of the gearbox; and
an upper electronics module removably coupled to the lower genset module, wherein the upper electronics module includes power electronics configured to convert an electrical output of the generator.

21. The power unit of claim 20, further including:
a first carry bar disposed on the lower genset module; and
a second carry bar disposed on the upper electronics module.

22. The power unit of claim 20, further including a rectifier disposed in the upper electronics module and coupled to the electrical output of the generator, wherein the rectifier is configured to produce a high-voltage direct current (DC) bus.

23. The power unit of claim 22, further including an inverter module disposed in the upper electronics module, wherein the inverter module is configured to generate 400 Hz, 270 VDC, 60 Hz, or 50 Hz power from the high-voltage DC bus.

24. The power unit of claim 20, wherein the lower genset module further includes a fuel tank.

25. The power unit of claim 20, wherein the generator is rated at least 30 kilovolt-amps and is configured to produce at least 60 kilowatts of electrical output.
